(19) United States
(12) Patent Application Publication
(10) Pub. No.: US 2024/0370278 A1
(43) Pub. Date: Nov. 7, 2024

(54) TECHNIQUES FOR MANAGING INTERACTIONS WITH UI ELEMENTS

(71) Applicant: Apple Inc., Cupertino, CA (US)

(72) Inventors: Joshua H. SHAFFER, Woodside, CA (US); Andrew B. CATO, Apex, NC (US); Kyle S. MACOMBER, Los Altos, CA (US); Luca BERNARDI, Santa Clara, CA (US); John S. HARPER, London (GB)

(21) Appl. No.: 18/613,426

(22) Filed: Mar. 22, 2024

Related U.S. Application Data
(60) Provisional application No. 63/464,536, filed on May 5, 2023.

(51) Int. Cl. G06F 9/451

(52) U.S. Cl. CPC G06F 9/451

(57) ABSTRACT

Some techniques are described herein for managing an interaction with a UI element of a respective application in a UI managed by a system process. Such techniques can allow the UI element to be (1) displayed by the system process with content provided by the respective application and (2) interacted with by a user without needing to display a user interface of the respective application. In some examples, an interaction with the UI element is provided to the system process and, via another system process, an action is identified and executed to update the UI element with different information provided by the respective application. Other techniques described herein can allow different endpoints of an application, such as different extensions or the application itself, to handle interactions with information provided by the application depending on a current state of an electronic device, the application, and/or the different extensions.

### CROSS-REFERENCE TO RELATED APPLICATIONS

The present application claims priority to U.S. Provisional Patent Application Ser. No. 63/464,536, entitled “TECHNIQUES FOR MANAGING INTERACTIONS WITH UI ELEMENTS” filed May 5, 2023, which is hereby incorporated by reference in its entirety for all purposes.

### BACKGROUND

Electronic devices often include applications that provide information for display in a user interface of an application and/or through a widget of the application. To interact with information from the application, a user typically needs to launch the application, wait for the application to launch, and navigate to a relevant section of the application. Accordingly, there is a need to improve techniques for interacting with applications.

### SUMMARY

Current techniques for managing interactions with applications are generally ineffective and/or inefficient. For example, some techniques require a user to navigate to a user interface of an application. This disclosure provides more effective and/or efficient techniques for managing interactions with applications using an example of a widget on a lockscreen of an electronic device. It should be recognized that other user interfaces can be used with techniques described herein. For example, a homescreen, a shared portion of a user interface, and/or a notification center can use techniques described herein. In addition, techniques described herein optionally complement or replace other techniques for managing interactions with applications.

Some techniques are described herein for managing an interaction with a UI element in a UI managed by a system process. While the UI element can correspond to a respective application, such techniques can allow the UI element to be (1) displayed by the system process with content provided by the respective application and (2) interacted with by a user without needing to display a user interface of the respective application. In some examples, an interaction with the UI element is provided to the system process and, via another system process, an action is identified and executed to update the UI element with different information provided by the respective application. Such updates can occur without launching and/or displaying a user interface of the respective application and, in some examples, without communicating with the respective application. Other techniques described herein can allow different endpoints of an application, such as different extensions of the application (e.g., each with its own endpoint) or the application itself (e.g., with its own endpoint), to handle interactions with information provided by the application depending on a current state of an electronic device, the application, and/or the different extensions. For example, the same interaction can be handled by either an extension of an application or the application itself based on whether the application is currently executing in the background.

In some examples, a method that is performed at a system process of a computer system is described. In some examples, the method comprises: while the computer system is displaying a user-interface view managed by the system process: receiving a first input corresponding to a user-interface element of the user-interface view; in response to receiving the first input, causing execution of an operation corresponding to the user-interface element, wherein execution of the operation is performed by an application corresponding to the user-interface element; after causing execution of the operation, receiving, from the application, a communication corresponding to a change to the user-interface view; and in response to receiving the communication, updating, based on the communication, display of the user-interface view.

In some examples, a non-transitory computer-readable storage medium storing one or more programs configured to be executed by one or more processors of a computer system executing a system process is described. In some examples, the one or more programs includes instructions for: while the computer system is displaying a user-interface view managed by the system process: receiving a first input corresponding to a user-interface element of the user-interface view; in response to receiving the first input, causing execution of an operation corresponding to the user-interface element, wherein execution of the operation is performed by an application corresponding to the user-interface element; after causing execution of the operation, receiving, from the application, a communication corresponding to a change to the user-interface view; and in response to receiving the communication, updating, based on the communication, display of the user-interface view.

In some examples, a transitory computer-readable storage medium storing one or more programs configured to be executed by one or more processors of a computer system executing a system process is described. In some examples, the one or more programs includes instructions for: while the computer system is displaying a user-interface view managed by the system process: receiving a first input corresponding to a user-interface element of the user-interface view; in response to receiving the first input, causing execution of an operation corresponding to the user-interface element, wherein execution of the operation is performed by an application corresponding to the user-interface element; after causing execution of the operation, receiving, from the application, a communication corresponding to a change to the user-interface view; and in response to receiving the communication, updating, based on the communication, display of the user-interface view.

In some examples, a computer system executing a system process is described. In some examples, the computer system comprises one or more processors and memory storing one or more program configured to be executed by the one or more processors. In some examples, the one or more programs includes instructions for: while the computer system is displaying a user-interface view managed by the system process: receiving a first input corresponding to a user-interface element of the user-interface view; in response to receiving the first input, causing execution of an operation corresponding to the user-interface element, wherein execution of the operation is performed by an application corresponding to the user-interface element; after causing execution of the operation, receiving, from the application, a communication corresponding to a change to the user-interface view; and in response to receiving the communication, updating, based on the communication, display of the user-interface view.

In some examples, a computer system executing a system process is described. In some examples, the computer system comprises means for performing each of the following steps: while the computer system is displaying a user-interface view managed by the system process: receiving a first input corresponding to a user-interface element of the user-interface view; in response to receiving the first input, causing execution of an operation corresponding to the user-interface element, wherein execution of the operation is performed by an application corresponding to the user-interface element; after causing execution of the operation, receiving, from the application, a communication corresponding to a change to the user-interface view; and in response to receiving the communication, updating, based on the communication, display of the user-interface view.

In some examples, a computer program product is described. In some examples, the computer program product comprises one or more programs configured to be executed by one or more processors of a computer system executing a system process. In some examples, the one or more programs include instructions for: while the computer system is displaying a user-interface view managed by the system process: receiving a first input corresponding to a user-interface element of the user-interface view; in response to receiving the first input, causing execution of an operation corresponding to the user-interface element, wherein execution of the operation is performed by an application corresponding to the user-interface element; after causing execution of the operation, receiving, from the application, a communication corresponding to a change to the user-interface view; and in response to receiving the communication, updating, based on the communication, display of the user-interface view.

In some examples, a method that is performed at an application of a computer system is described. In some examples, the method comprises: while the computer system is displaying a user-interface view managed by a system process of the computer system: receiving, from the system process, a request to perform an operation corresponding to an interaction with a user-interface element of the user-interface view, wherein the user-interface element corresponds to the application; in response to receiving the request to perform the operation, performing the operation; and sending, to the system process, a request to change the user-interface view based on the request to perform the operation.

In some examples, a non-transitory computer-readable storage medium storing one or more programs configured to be executed by one or more processors of a computer system executing an application is described. In some examples, the one or more programs includes instructions for: while the computer system is displaying a user-interface view managed by a system process of the computer system: receiving, from the system process, a request to perform an operation corresponding to an interaction with a user-interface element of the user-interface view, wherein the user-interface element corresponds to the application; in response to receiving the request to perform the operation, performing the operation; and sending, to the system process, a request to change the user-interface view based on the request to perform the operation.

In some examples, a transitory computer-readable storage medium storing one or more programs configured to be executed by one or more processors of a computer system executing an application is described. In some examples, the one or more programs includes instructions for: while the computer system is displaying a user-interface view managed by a system process of the computer system: receiving, from the system process, a request to perform an operation corresponding to an interaction with a user-interface element of the user-interface view, wherein the user-interface element corresponds to the application; in response to receiving the request to perform the operation, performing the operation; and sending, to the system process, a request to change the user-interface view based on the request to perform the operation.

In some examples, a computer system executing an application is described. In some examples, the computer system comprises one or more processors and memory storing one or more program configured to be executed by the one or more processors. In some examples, the one or more programs includes instructions for: while the computer system is displaying a user-interface view managed by a system process of the computer system: receiving, from the system process, a request to perform an operation corresponding to an interaction with a user-interface element of the user-interface view, wherein the user-interface element corresponds to the application; in response to receiving the request to perform the operation, performing the operation; and sending, to the system process, a request to change the user-interface view based on the request to perform the operation.

In some examples, a computer system executing an application is described. In some examples, the computer system comprises means for performing each of the following steps: while the computer system is displaying a user-interface view managed by a system process of the computer system: receiving, from the system process, a request to perform an operation corresponding to an interaction with a user-interface element of the user-interface view, wherein the user-interface element corresponds to the application; in response to receiving the request to perform the operation, performing the operation; and sending, to the system process, a request to change the user-interface view based on the request to perform the operation.

In some examples, a computer program product is described. In some examples, the computer program product comprises one or more programs configured to be executed by one or more processors of a computer system executing an application. In some examples, the one or more programs include instructions for: while the computer system is displaying a user-interface view managed by a system process of the computer system: receiving, from the system process, a request to perform an operation corresponding to an interaction with a user-interface element of the user-interface view, wherein the user-interface element corresponds to the application; in response to receiving the request to perform the operation, performing the operation; and sending, to the system process, a request to change the user-interface view based on the request to perform the operation.

In some examples, a method that is performed at a system process of a computer system is described. In some examples, the method comprises: receiving an indication of a user-interface element corresponding to an application; in response to receiving the indication of the user-interface element corresponding to the application, identifying an action corresponding to the user-interface element; and in response to identifying the action corresponding to the user-interface element: in accordance with a determination that the application is in a first state, sending, to a first endpoint of the application, an instruction to perform the action; and in accordance with a determination that the application is in a second state different from the first state, sending, to a second endpoint of the application different from the first endpoint of the application, the instruction to perform the action.

In some examples, a non-transitory computer-readable storage medium storing one or more programs configured to be executed by one or more processors of a computer system executing a system process is described. In some examples, the one or more programs includes instructions for: receiving an indication of a user-interface element corresponding to an application; in response to receiving the indication of the user-interface element corresponding to the application, identifying an action corresponding to the user-interface element; and in response to identifying the action corresponding to the user-interface element: in accordance with a determination that the application is in a first state, sending, to a first endpoint of the application, an instruction to perform the action; and in accordance with a determination that the application is in a second state different from the first state, sending, to a second endpoint of the application different from the first endpoint of the application, the instruction to perform the action.

In some examples, a transitory computer-readable storage medium storing one or more programs configured to be executed by one or more processors of a computer system executing a system process is described. In some examples, the one or more programs includes instructions for: receiving an indication of a user-interface element corresponding to an application; in response to receiving the indication of the user-interface element corresponding to the application, identifying an action corresponding to the user-interface element; and in response to identifying the action corresponding to the user-interface element: in accordance with a determination that the application is in a first state, sending, to a first endpoint of the application, an instruction to perform the action; and in accordance with a determination that the application is in a second state different from the first state, sending, to a second endpoint of the application different from the first endpoint of the application, the instruction to perform the action.

In some examples, a computer system executing a system process is described. In some examples, the computer system comprises one or more processors and memory storing one or more program configured to be executed by the one or more processors. In some examples, the one or more programs includes instructions for: receiving an indication of a user-interface element corresponding to an application; in response to receiving the indication of the user-interface element corresponding to the application, identifying an action corresponding to the user-interface element; and in response to identifying the action corresponding to the user-interface element: in accordance with a determination that the application is in a first state, sending, to a first endpoint of the application, an instruction to perform the action; and in accordance with a determination that the application is in a second state different from the first state, sending, to a second endpoint of the application different from the first endpoint of the application, the instruction to perform the action.

In some examples, a computer system executing a system process is described. In some examples, the computer system comprises means for performing each of the following steps: receiving an indication of a user-interface element corresponding to an application; in response to receiving the indication of the user-interface element corresponding to the application, identifying an action corresponding to the user-interface element; and in response to identifying the action corresponding to the user-interface element: in accordance with a determination that the application is in a first state, sending, to a first endpoint of the application, an instruction to perform the action; and in accordance with a determination that the application is in a second state different from the first state, sending, to a second endpoint of the application different from the first endpoint of the application, the instruction to perform the action.

In some examples, a computer program product is described. In some examples, the computer program product comprises one or more programs configured to be executed by one or more processors of a computer system executing a system process. In some examples, the one or more programs include instructions for: receiving an indication of a user-interface element corresponding to an application; in response to receiving the indication of the user-interface element corresponding to the application, identifying an action corresponding to the user-interface element; and in response to identifying the action corresponding to the user-interface element: in accordance with a determination that the application is in a first state, sending, to a first endpoint of the application, an instruction to perform the action; and in accordance with a determination that the application is in a second state different from the first state, sending, to a second endpoint of the application different from the first endpoint of the application, the instruction to perform the action.

In some examples, a method that is performed by a computer system is described. In some examples, the method comprises: in a case where an application of a computer system is in a first state, receiving, by a first endpoint of the application from a first system process of the computer system, an instruction to perform an action, wherein the action corresponds to a user-interface element of a user-interface view managed by a second system process of the computer system; in response to the first endpoint receiving the instruction to perform the action, executing, by the first endpoint of the application, the action; in a case where the application is in a second state different from the first state, receiving, by a second endpoint of the application from the first system process, the instruction to perform the action, wherein the second endpoint is different from the first endpoint; and in response to the second endpoint receiving the instruction to perform the action, executing, by the second endpoint of the application, the action.

In some examples, a non-transitory computer-readable storage medium storing one or more programs configured to be executed by one or more processors of a computer system is described. In some examples, the one or more programs includes instructions for: in a case where an application of a computer system is in a first state, receiving, by a first endpoint of the application from a first system process of the computer system, an instruction to perform an action, wherein the action corresponds to a user-interface element of a user-interface view managed by a second system process of the computer system; in response to the first endpoint receiving the instruction to perform the action, executing, by the first endpoint of the application, the action; in a case where the application is in a second state different from the first state, receiving, by a second endpoint of the application from the first system process, the instruction to perform the action, wherein the second endpoint is different from the first endpoint; and in response to the second endpoint receiving the instruction to perform the action, executing, by the second endpoint of the application, the action.

In some examples, a transitory computer-readable storage medium storing one or more programs configured to be executed by one or more processors of a computer system is described. In some examples, the one or more programs includes instructions for: in a case where an application of a computer system is in a first state, receiving, by a first endpoint of the application from a first system process of the computer system, an instruction to perform an action, wherein the action corresponds to a user-interface element of a user-interface view managed by a second system process of the computer system; in response to the first endpoint receiving the instruction to perform the action, executing, by the first endpoint of the application, the action; in a case where the application is in a second state different from the first state, receiving, by a second endpoint of the application from the first system process, the instruction to perform the action, wherein the second endpoint is different from the first endpoint; and in response to the second endpoint receiving the instruction to perform the action, executing, by the second endpoint of the application, the action.

In some examples, a computer system comprising one or more processors and memory storing one or more program configured to be executed by the one or more processors is described. In some examples, the one or more programs includes instructions for: in a case where an application of a computer system is in a first state, receiving, by a first endpoint of the application from a first system process of the computer system, an instruction to perform an action, wherein the action corresponds to a user-interface element of a user-interface view managed by a second system process of the computer system; in response to the first endpoint receiving the instruction to perform the action, executing, by the first endpoint of the application, the action; in a case where the application is in a second state different from the first state, receiving, by a second endpoint of the application from the first system process, the instruction to perform the action, wherein the second endpoint is different from the first endpoint; and in response to the second endpoint receiving the instruction to perform the action, executing, by the second endpoint of the application, the action.

In some examples, a computer system is described. In some examples, the computer system comprises means for performing each of the following steps: in a case where an application of a computer system is in a first state, receiving, by a first endpoint of the application from a first system process of the computer system, an instruction to perform an action, wherein the action corresponds to a user-interface element of a user-interface view managed by a second system process of the computer system; in response to the first endpoint receiving the instruction to perform the action, executing, by the first endpoint of the application, the action; in a case where the application is in a second state different from the first state, receiving, by a second endpoint of the application from the first system process, the instruction to perform the action, wherein the second endpoint is different from the first endpoint; and in response to the second endpoint receiving the instruction to perform the action, executing, by the second endpoint of the application, the action.

In some examples, a computer program product is described. In some examples, the computer program product comprises one or more programs configured to be executed by one or more processors of a computer system. In some examples, the one or more programs include instructions for: in a case where an application of a computer system is in a first state, receiving, by a first endpoint of the application from a first system process of the computer system, an instruction to perform an action, wherein the action corresponds to a user-interface element of a user-interface view managed by a second system process of the computer system; in response to the first endpoint receiving the instruction to perform the action, executing, by the first endpoint of the application, the action; in a case where the application is in a second state different from the first state, receiving, by a second endpoint of the application from the first system process, the instruction to perform the action, wherein the second endpoint is different from the first endpoint; and in response to the second endpoint receiving the instruction to perform the action, executing, by the second endpoint of the application, the action.

In some examples, a non-transitory computer-readable storage medium storing a plurality of programs configured to be executed by one or more processors is described. In some examples, the plurality of programs include: a first program corresponding to an application, wherein the first program is configured to: receive, via a system process different from the plurality of programs, user-interaction data; and in response to receiving the user-interaction data, provide, via the system process, data for display in a user interface managed by the system process; and a second program corresponding to an extension of the application, wherein the second program is configured to execute separate from the first program, and wherein the second program is configured to: receive, via the system process, the user-interaction data; and in response to receiving the user-interaction data, provide, via the system process, data for display in the user interface managed by the system process.

In some examples, a computer system storing a plurality of programs configured to be executed by one or more processors of the computer system is described. In some examples, the plurality of programs include: a first program corresponding to an application, wherein the first program is configured to: receive, via a system process different from the plurality of programs, user-interaction data; and in response to receiving the user-interaction data, provide, via the system process, data for display in a user interface managed by the system process; and a second program corresponding to an extension of the application, wherein the second program is configured to execute separate from the first program, and wherein the second program is configured to: receive, via the system process, the user-interaction data; and in response to receiving the user-interaction data, provide, via the system process, data for display in the user interface managed by the system process.

In some examples, a non-transitory computer-readable storage medium storing an application configured to be executed by one or more processors of a computer system is described. In some examples, the application includes instructions for: receiving, via a system process different from the plurality of programs, user-interaction data; in response to receiving the user-interaction data, providing, via the system process, data for display in a user interface managed by the system process; and causing a second program to execute, wherein the second program is configured to execute separate from the application, and wherein the second program is configured to: receive, via the system process, the user-interaction data; and in response to receiving the user-interaction data, provide, via the system process, data for display in the user interface managed by the system process.

In some examples, a computer system executing an application is described. In some examples, the application includes instructions for: receiving, via a system process different from the plurality of programs, user-interaction data; in response to a first program of the application receiving the user-interaction data, providing, via the system process, data for display in a user interface managed by the system process; and causing a second program to execute, wherein the second program is configured to execute separate from the first program, and wherein the second program is configured to: receive, via the system process, the user-interaction data; and in response to the second program receiving the user-interaction data, provide, via the system process, data for display in the user interface managed by the system process.

Executable instructions for performing these functions are, optionally, included in a non-transitory computer-readable storage medium or other computer program product configured for execution by one or more processors. Executable instructions for performing these functions are, optionally, included in a transitory computer-readable storage medium or other computer program product configured for execution by one or more processors.

### DESCRIPTION OF THE FIGURES

For a better understanding of the various described embodiments, reference should be made to the Detailed Description below, in conjunction with the following drawings in which like reference numerals refer to corresponding parts throughout the figures.

FIG. 1 is a block diagram illustrating a compute system in accordance with some examples.

FIG. 2 is a block diagram illustrating a device with interconnected subsystems in accordance with some examples.

FIG. 3 is a block diagram illustrating a device that includes an operating system and multiple applications in accordance with some examples.

FIG. 4 is a block diagram illustrating different operations that occur with respect to different processes of a device to handle an interaction with a UI view in accordance with some examples.

FIG. 5 is a block diagram illustrating different operations that occur with respect to different processes of a device to contextually handle an interaction with a UI view in accordance with some examples.

FIG. 6 is a flow diagram illustrating a method for a system process to handle user input corresponding to UI elements in accordance with some examples.

FIG. 7 is a flow diagram illustrating a method for an application to handle user input corresponding to user-interface elements in accordance with some examples.

FIG. 8 is a flow diagram illustrating a method for sending an instruction to different endpoints of an application in accordance with some examples.

FIG. 9 is a flow diagram illustrating a method for handling instructions to perform operations in accordance with some examples.

FIG. 10 is a flow diagram illustrating a method for handling user-interaction data from the perspective of multiple programs in accordance with some examples.

FIG. 11 is a flow diagram illustrating a method for handling instructions to perform operations in accordance with some examples.

### DETAILED DESCRIPTION

The following description sets forth exemplary methods, parameters, and the like. It should be recognized, however, that such description is not intended as a limitation on the scope of the present disclosure but is instead provided as a description of exemplary embodiments.

Methods and/or processes described herein can include one or more steps that are contingent upon one or more conditions being satisfied. It should be understood that a method can occur over multiple iterations of the same process with different steps of the method being satisfied in different iterations. For example, if a method requires performing a first step upon a determination that a set of one or more criteria is met and a second step upon a determination that the set of one or more criteria is not met, a person of ordinary skill in the art would appreciate that the steps of the method are repeated until both conditions, in no particular order, are satisfied. Thus, a method described with steps that are contingent upon a condition being satisfied can be rewritten as a method that is repeated until each of the conditions described in the method are satisfied. This, however, is not required of system or computer readable medium claims where the system or computer readable medium claims include instructions for performing one or more steps that are contingent upon one or more conditions being satisfied. Because the instructions for the system or computer readable medium claims are stored in one or more processors and/or at one or more memory locations, the system or computer readable medium claims include logic that can determine whether the one or more conditions have been satisfied without explicitly repeating steps of a method until all of the conditions upon which steps in the method are contingent have been satisfied. A person having ordinary skill in the art would also understand that, similar to a method with contingent steps, a system or computer readable storage medium can repeat the steps of a method as many times as needed to ensure that all of the contingent steps have been performed.

Although the following description uses terms “first,” “second,” etc. to describe various elements, these elements should not be limited by the terms. In some examples, these terms are used to distinguish one element from another. For example, a first subsystem could be termed a second subsystem, and, similarly, a subsystem device could be termed a subsystem device, without departing from the scope of the various described embodiments. In some examples, the first subsystem and the second subsystem are two separate references to the same subsystem. In some embodiments, the first subsystem and the second subsystem are both subsystem, but they are not the same subsystem or the same type of subsystem.

The terminology used in the description of the various described embodiments herein is for the purpose of describing particular embodiments only and is not intended to be limiting. As used in the description of the various described embodiments and the appended claims, the singular forms “a,” “an,” and “the” are intended to include the plural forms as well, unless the context clearly indicates otherwise. It will also be understood that the term “and/or” as used herein refers to and encompasses any and all possible combinations of one or more of the associated listed items. It will be further understood that the terms “includes,” “including,” “comprises,” and/or “comprising,” when used in this specification, specify the presence of stated features, integers, steps, operations, elements, and/or components, but do not preclude the presence or addition of one or more other features, integers, steps, operations, elements, components, and/or groups thereof.

The term “if” is, optionally, construed to mean “when,” “upon,” “in response to determining,” “in response to detecting,” or “in accordance with a determination that” depending on the context. Similarly, the phrase “if it is determined” or “if [a stated condition or event] is detected” is, optionally, construed to mean “upon determining,” “in response to determining,” “upon detecting [the stated condition or event],” “in response to detecting [the stated condition or event],” or “in accordance with a determination that [the stated condition or event]” depending on the context.

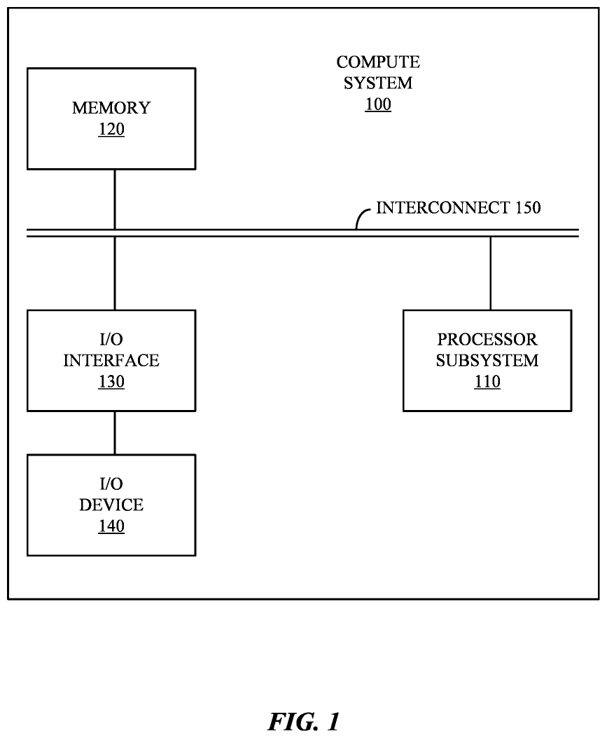

Turning to FIG. 1, a block diagram of compute system 100 is illustrated. Compute system 100 is a non-limiting example of a compute system that can be used to perform functionality described herein. It should be recognized that other computer architectures of a compute system can be used to perform functionality described herein.

In the illustrated example, compute system 100 includes processor subsystem 110 communicating with (e.g., wired or wirelessly) memory 120 (e.g., a system memory) and I/O interface 130 via interconnect 150 (e.g., a system bus, one or more memory locations, or other communication channel for connecting multiple components of compute system 100). In addition, I/O interface 130 is communicating with (e.g., wired or wirelessly) to I/O device 140. In some examples, I/O interface 130 is included with I/O device 140 such that the two are a single component. It should be recognized that there can be one or more I/O interfaces, with each I/O interface communicating with one or more I/O devices. In some examples, multiple instances of processor subsystem 110 can be communicating via interconnect 150.

Compute system 100 can be any of various types of devices, including, but not limited to, a system on a chip, a server system, a personal computer system (e.g., a smartphone, a smartwatch, a wearable device, a tablet, a laptop computer, and/or a desktop computer), a sensor, or the like. In some examples, compute system 100 is included or communicating with a physical component for the purpose of modifying the physical component in response to an instruction. In some examples, compute system 100 receives an instruction to modify a physical component and, in response to the instruction, causes the physical component to be modified. In some examples, the physical component is modified via an actuator, an electric signal, and/or algorithm. Examples of such physical components include an acceleration control, a break, a gear box, a hinge, a motor, a pump, a refrigeration system, a spring, a suspension system, a steering control, a pump, a vacuum system, and/or a valve. In some examples, a sensor includes one or more hardware components that detect information about a physical environment in proximity to (e.g., surrounding) the sensor. In some examples, a hardware component of a sensor includes a sensing component (e.g., an image sensor or temperature sensor), a transmitting component (e.g., a laser or radio transmitter), a receiving component (e.g., a laser or radio receiver), or any combination thereof. Examples of sensors include an angle sensor, a chemical sensor, a brake pressure sensor, a contact sensor, a non-contact sensor, an electrical sensor, a flow sensor, a force sensor, a gas sensor, a humidity sensor, an image sensor (e.g., a camera sensor, a radar sensor, and/or a LiDAR sensor), an inertial measurement unit, a leak sensor, a level sensor, a light detection and ranging system, a metal sensor, a motion sensor, a particle sensor, a photoelectric sensor, a position sensor (e.g., a global positioning system), a precipitation sensor, a pressure sensor, a proximity sensor, a radio detection and ranging system, a radiation sensor, a speed sensor (e.g., measures the speed of an object), a temperature sensor, a time-of-flight sensor, a torque sensor, and an ultrasonic sensor. In some examples, a sensor includes a combination of multiple sensors. In some examples, sensor data is captured by fusing data from one sensor with data from one or more other sensors. Although a single compute system is shown in FIG. 1, compute system 100 can also be implemented as two or more compute systems operating together.

In some examples, processor subsystem 110 includes one or more processors or processing units configured to execute program instructions to perform functionality described herein. For example, processor subsystem 110 can execute an operating system, a middleware system, one or more applications, or any combination thereof.

In some examples, the operating system manages resources of compute system 100. Examples of types of operating systems covered herein include batch operating systems (e.g., Multiple Virtual Storage (MVS)), time-sharing operating systems (e.g., Unix), distributed operating systems (e.g., Advanced Interactive executive (AIX), network operating systems (e.g., Microsoft Windows Server), and real-time operating systems (e.g., QNX). In some examples, the operating system includes various procedures, sets of instructions, software components, and/or drivers for controlling and managing general system tasks (e.g., memory management, storage device control, power management, or the like) and for facilitating communication between various hardware and software components. In some examples, the operating system uses a priority-based scheduler that assigns a priority to different tasks that processor subsystem 110 can execute. In such examples, the priority assigned to a task is used to identify a next task to execute. In some examples, the priority-based scheduler identifies a next task to execute when a previous task finishes executing. In some examples, the highest priority task runs to completion unless another higher priority task is made ready.

In some examples, the middleware system provides one or more services and/or capabilities to applications (e.g., the one or more applications running on processor subsystem 110) outside of what the operating system offers (e.g., data management, application services, messaging, authentication, API management, or the like). In some examples, the middleware system is designed for a heterogeneous computer cluster to provide hardware abstraction, low-level device control, implementation of commonly used functionality, message-passing between processes, package management, or any combination thereof. Examples of middleware systems include Lightweight Communications and Marshalling (LCM), PX4, Robot Operating System (ROS), and ZeroMQ. In some examples, the middleware system represents processes and/or operations using a graph architecture, where processing takes place in nodes that can receive, post, and multiplex sensor data messages, control messages, state messages, planning messages, actuator messages, and other messages. In such examples, the graph architecture can define an application (e.g., an application executing on processor subsystem 110 as described above) such that different operations of the application are included with different nodes in the graph architecture.

In some examples, a message sent from a first node in a graph architecture to a second node in the graph architecture is performed using a publish-subscribe model, where the first node publishes data on a channel in which the second node can subscribe. In such examples, the first node can store data in memory (e.g., memory 120 or some local memory of processor subsystem 110) and notify the second node that the data has been stored in the memory. In some examples, the first node notifies the second node that the data has been stored in the memory by sending a pointer (e.g., a memory pointer, such as an identification of a memory location) to the second node so that the second node can access the data from where the first node stored the data. In some examples, the first node would send the data directly to the second node so that the second node would not need to access a memory based on data received from the first node.

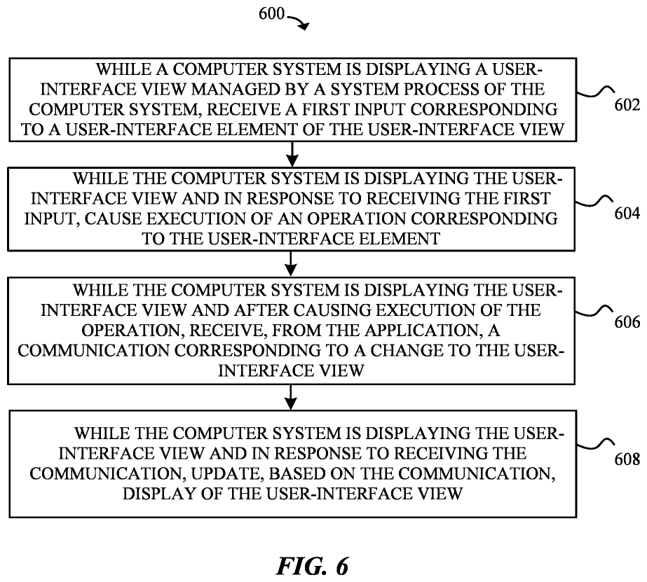

Memory 120 can include a computer readable medium (e.g., non-transitory or transitory computer readable medium) usable to store (e.g., configured to store, assigned to store, and/or that stores) program instructions executable by processor subsystem 110 to cause compute system 100 to perform various operations described herein. For example, memory 120 can store program instructions to implement the functionality associated with methods 600, 700, 800, and 900 (FIGS. 6, 7, 8, and 9) described below.

Memory 120 can be implemented using different physical, non-transitory memory media, such as hard disk storage, floppy disk storage, removable disk storage, flash memory, random access memory (RAM-SRAM, EDO RAM, SDRAM, DDR SDRAM, RAMBUS RAM, or the like), read only memory (PROM, EEPROM, or the like), or the like. Memory in compute system 100 is not limited to primary storage such as memory 120. Compute system 100 can also include other forms of storage such as cache memory in processor subsystem 110 and secondary storage on I/O device 140 (e.g., a hard drive, storage array, etc.). In some examples, these other forms of storage can also store program instructions executable by processor subsystem 110 to perform operations described herein. In some examples, processor subsystem 110 (or each processor within processor subsystem 110) contains a cache or other form of on-board memory.

I/O interface 130 can be any of various types of interfaces configured to communicate with other devices. In some examples, I/O interface 130 includes a bridge chip (e.g., Southbridge) from a front-side bus to one or more back-side buses. I/O interface 130 can communicate with one or more I/O devices (e.g., I/O device 140) via one or more corresponding buses or other interfaces. Examples of I/O devices include storage devices (hard drive, optical drive, removable flash drive, storage array, SAN, or their associated controller), network interface devices (e.g., to a local or wide-area network), sensor devices (e.g., camera, radar, LiDAR, ultrasonic sensor, GPS, inertial measurement device, or the like), and auditory or visual output devices (e.g., speaker, light, screen, projector, or the like). In some examples, compute system 100 is communicating with a network via a network interface device (e.g., configured to communicate over Wi-Fi, Bluetooth, Ethernet, or the like). In some examples, compute system 100 is directly or wired to the network.

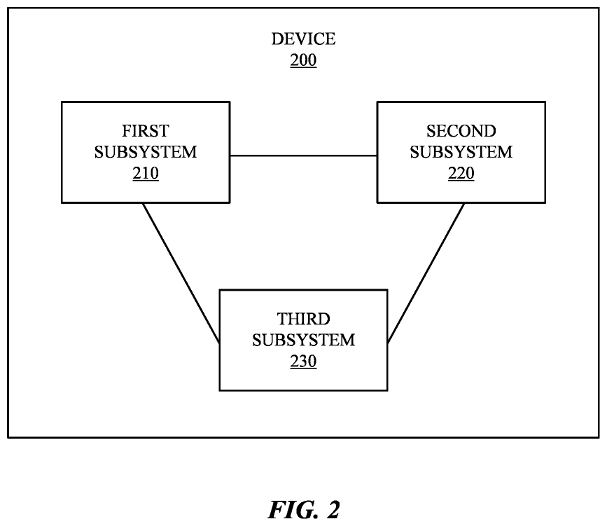

FIG. 2 illustrates a block diagram of device 200 with interconnected subsystems in accordance with some examples. In the illustrated example, device 200 includes three different subsystems (i.e., first subsystem 210, second subsystem 220, and third subsystem 230) communicating with (e.g., wired or wirelessly) each other, creating a network (e.g., a personal area network, a local area network, a wireless local area network, a metropolitan area network, a wide area network, a storage area network, a virtual private network, an enterprise internal private network, a campus area network, a system area network, and/or a controller area network). An example of a possible computer architecture of a subsystem as included in FIG. 2 is described in FIG. 1 (i.e., compute system 100). Although three subsystems are shown in FIG. 2, device 200 can include more or fewer subsystems.

In some examples, some subsystems are not connected to other subsystem (e.g., first subsystem 210 can be connected to second subsystem 220 and third subsystem 230 but second subsystem 220 cannot be connected to third subsystem 230). In some examples, some subsystems are connected via one or more wires while other subsystems are wirelessly connected. In some examples, messages are set between the first subsystem 210, second subsystem 220, and third subsystem 230, such that when a respective subsystem sends a message the other subsystems receive the message (e.g., via a wire and/or a bus). In some examples, one or more subsystems are wirelessly connected to one or more compute systems outside of device 200, such as a server system. In such examples, the subsystem can be configured to communicate wirelessly to the one or more compute systems outside of device 200.

In some examples, device 200 includes a housing that fully or partially encloses subsystems 210-230. Examples of device 200 include a home-appliance device (e.g., a refrigerator or an air conditioning system), a robot (e.g., a robotic arm or a robotic vacuum), and a vehicle. In some examples, device 200 is configured to navigate (with or without user input) in a physical environment.

In some examples, one or more subsystems of device 200 are used to control, manage, and/or receive data from one or more other subsystems of device 200 and/or one or more compute systems remote from device 200. For example, first subsystem 210 and second subsystem 220 can each be a camera that captures images, and third subsystem 230 can use the captured images for decision making. In some examples, at least a portion of device 200 functions as a distributed compute system. For example, a task can be split into different portions, where a first portion is executed by first subsystem 210 and a second portion is executed by second subsystem 220.

As used herein, an “installed application” refers to a software application that has been downloaded onto a computer system (e.g., compute system 100 and/or device 200) and is ready to be launched (e.g., become opened) on the device. In some examples, a downloaded application becomes an installed application by way of an installation program that extracts program portions from a downloaded package and integrates the extracted portions with the operating system of the computer system.

As used herein, the terms “open application” or “executing application” refer to a software application with retained state information (e.g., as part of a system/global internal state and/or an application internal state). An open or executing application is, optionally, any one of the following types of applications:
an active application (or foreground/active processes), which is currently displayed on a display screen of the device that the application is being used on;
a background application (or background processes), which is not currently displayed, but one or more processes for the application are being processed by one or more processors; and
a suspended or hibernated application, which is not running, but has state information that is stored in memory (volatile and non-volatile, respectively) and that can be used to resume execution of the application.

As used herein, the term “closed application” refers to software applications without retained state information (e.g., state information for closed applications is not stored in a memory of the device). Accordingly, closing an application includes stopping and/or removing application processes for the application and removing state information for the application from the memory of the device. Generally, opening a second application while in a first application does not close the first application. When the second application is displayed and the first application ceases to be displayed, the first application becomes a background application.

Attention is now directed towards techniques for managing interactions with UI elements corresponding to applications (e.g., user applications and/or non-system applications). Such techniques are described in the context of a widget on a lockscreen of an electronic device. It should be recognized that other user-interface views can be used with techniques described herein. For example, a media selection interface of a television and/or dashboard of a vehicle can use techniques described herein. In addition, techniques described herein optionally complement or replace other techniques for managing interactions with UI elements corresponding to applications.

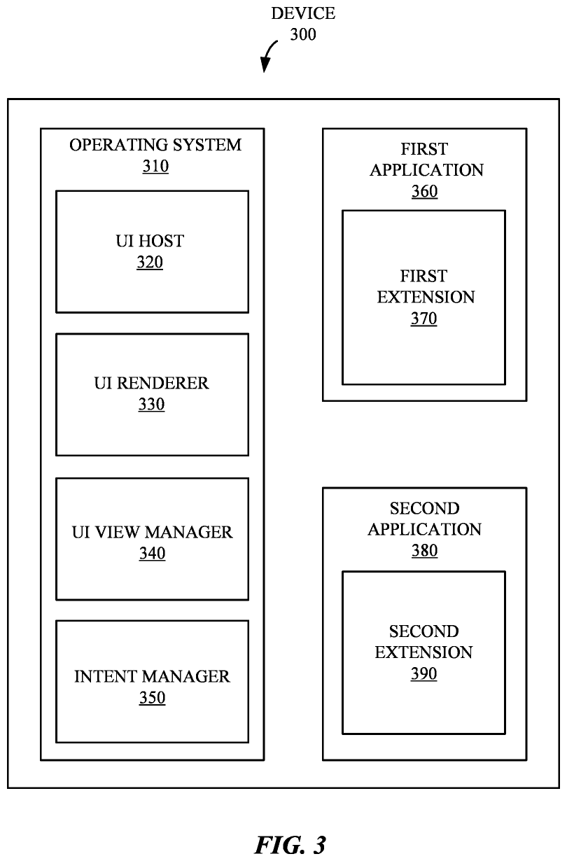

FIG. 3 is a block diagram illustrating a device (e.g., device 300) that includes an operating system (e.g., operating system 310) and multiple applications (e.g., first application 360 and second application 380) in accordance with some examples. In some examples, device 300 is a phone, a tablet, a laptop, a desktop computer, and/or a wearable device. It should be recognized that device 300 can include more or fewer components than illustrated in FIG. 3. In addition, some components can be (1) split into multiple components (e.g., aspects of UI renderer 330 and can be split into multiple system components executing in operating system 310), (2) combined with other components (e.g., UI view manager 340 can be combined with intent manager 350), (3) and/or (3) integrated into or outside of operating system 310, including inside of one of the multiple applications or in a user space of device 300 (e.g., intent manager 350 can execute outside of operating system 310 in one or each of the multiple applications or as a user process outside of operating system 310 and outside of the multiple applications).

As mentioned above, device 300 includes operating system 310. In some examples, operating system 310 includes one or more aspects as an operating system described above with respect to FIG. 1. For example, operating system 310 can manage resources for device 300. In some examples, operating system 310 manages interactions with input and/or output devices of and/or in communication with device 300. For example, operating system 310 can detect input (e.g., user input, such as a tap on a touch-sensitive surface, a click of a mouse button, a press of a key on a keyboard, and/or movement of a finger on a touch pad) (e.g., an event corresponding to input) performed with respect to an input device of device 300 and determine how to respond, including launching, activating, and/or notifying one or more applications and/or processes of device 300.

As illustrated, operating system 310 includes UI host 320, UI renderer 330, UI view manager 340, and intent manager 350. In some examples, UI host 320 is a system process of operating system 310 that manages UI views provided by operating system 310. Examples of UI views provided by operating system 310 include those that include content received by device 300 and/or provided by one or more applications installed on device 300, such as a lockscreen (e.g., a UI, displayed (1) while device 300 is locked and causing output and/or (2) before dismissing the lockscreen) (e.g., a UI with limited functionality as compared to other UIs of device 300 when device 300 is unlocked), a homescreen (e.g., a UI, displayed while device 300 is unlocked, with (1) representations of different applications that are selectable to display UI of the different applications and/or (2) content provided by applications in the form of widgets), and/or a notification center (e.g., a UI including representations of events that occurred with respect to different applications of device 300, each representation including content received by device 300 and/or provided by an application of device 300).

In some examples, UI host 320 communicates with UI renderer 330 to render UI elements for display. In some examples, in response to communicating with UI renderer 330, UI host 320 receives and causes display of rendered UI elements by one or more output devices of device 300. In other examples, in response to communicating with UI host 320, UI renderer 330 causes display of rendered UI elements by one or more output devices of device 300. In either set of examples previously mentioned, UI renderer 330 can combine different UI elements into a single UI that is prepared for display by device 330. In some examples, UI host 320 and/or UI renderer 330 communicates with UI view manager 340 to obtain at least some content provided by other applications of device 300. In such examples, UI host 320 and/or UI renderer 330 can create an area of a UI to include content from another application and can communicate with UI view manager 340 to obtain the content for the area of the UI.

In some examples, UI view manager 340 communicates with applications (e.g., first application 360, first extension 370, second application 380, and/or second extension 390) to store archives corresponding to respective applications. In some examples, an archive corresponding to a respective application can be stored by UI view manager 340 and used by UI view manager 340 without initiating, executing, displaying a user interface of, and/or communicating with the respective application. For example, an archive can define a UI element in the form of a virtual button that, when selected, causes the UI element to appear depressed and/or a color of a different UI element to be changed. In such an example, execution of the archive (including causing the UI element to appear depressed and/or the color of the different UI element to be changed) can be performed without communicating with the respective application, avoiding the need to execute the respective application. In some examples, an archive (1) corresponds to a widget of an application and/or (2) includes instructions to display and/or render a UI of the widget. In some examples, an archive includes a data structure used to render at least a portion of a UI view corresponding to the widget. In some examples, an archive includes instructions (e.g., code and/or definition of one or more operations to render a UI element via UI host 320 and/or UI renderer 330) and/or rendered UI views (e.g., rendered by an application and/or an extension of an application, optionally via UI renderer 330) for UI elements corresponding to the archive. Such UI elements can include information of what is to be displayed in response to different events occurring (e.g., user interactions with the UI elements, content received by device 300, and/or time passing). In some examples, an archive includes a timeline of events that define what to display and/or when to display different UI elements. The timeline of events can be part of and/or separate from the UI elements.

In some examples, UI view manager 340 manages UI views corresponding to widgets of different applications (e.g., and/or other types of UI elements). Such UI views can be displayed and/or have their interactions managed by UI view manager 340 (e.g., instead of requiring applications for each widget to be executing when content by the widget is being displayed). For example, UI view manager 340 can cause display of a lockscreen for device 300 with UI views of widgets corresponding to 10 different applications without all 10 applications needing to be executing. In some examples, a lockscreen for device 300 is a foreground process (e.g., an example of a live process, which also includes a background process, that is actively executing on device 300 via UI host 320 (e.g., UI host 320 can be specific to the lockscreen such that a different UI host is specific to a different system UI (e.g., homescreen and/or notification center))). In such examples, applications (e.g., first application 360, first extension 370, second application 380, and/or second extension 390) do not need to be (e.g., and are not) live processes (sometimes referred to as suspended, hibernated, or closed processes) when a UI view managed by UI view manager 340 is being displayed unless UI view manager 340 needs information and/or updates from a respective application, as discussed further below.

As mentioned above, device 300 includes multiple applications. Such applications can correspond to different features, organizations, and/or parties. A non-limiting list of examples of application include accessory applications (e.g., an application to control and/or view information for one or more accessories in communication with device 300), list applications (e.g., an application to view and modify lists of data), media applications (e.g., an application to control output of and/or view information for media (e.g., audio (e.g., recordings, music, and/or podcasts), video, and/or images)) (e.g., stored by device 300 and/or stored by a remote device in communication with device 300), and vehicle applications (e.g., an application to controls and/or view information for vehicles in communication with device 300).

In some examples, an application includes an extension (e.g., a portion of the application and/or a process that executes separate from the application) for providing features not provided by or also provided by the application. In some examples, an extension (1) corresponds to a widget of the application and/or (2) includes instructions to display and/or render a UI of the widget. In some examples, an extension generates data to be presented in the widget and/or a UI view. It should be recognized that other types of extensions, that does not correspond to a widget, are within scope of this disclosure and that extensions refers to a set of one or more features. As illustrated, first application 360 includes first extension 370, and second application 380 includes second extension 390. In some examples, first application 360 and/or second application 380 are installed on device 300 and operate and/or execute at least partially outside of operating system 310.

In some examples, first application 360 and/or second application 380 are installed via an online repository of installable applications (sometimes referred to as an application store). In such examples, installing first application 360 via the online repository can include installing first extension 370 of first application 360. In other examples, installing first application 360 via the online repository does not include installing first extension 370 and instead first application 360 downloads and/or installs first extension 370 after first application 360 is installed on device 300.

Using the configuration described above with respect to FIG. 3, techniques are described herein for processing interactions with UI views managed by UI view manager 340. Such processing can be performed via intent manager 350 and/or UI view manager 340.

In some examples, using intent manager 350, an interaction with a UI view (e.g., a UI element of the UI view) is processed using an intent provided by an application. For example, an application (e.g., an application itself or an extension of the application) can define one or more operations to occur as a result of (e.g., in response to) an event occurring (e.g., input is detected, a threshold is reached, and/or an amount of time has passed). The one or more operations can be any code provided by the application to be executed by a system process (e.g., UI view manager 340 and/or intent manager 350). Such code can cause (1) the system process to execute one or more instructions and/or (2) an endpoint (e.g., a particular feature) of the application and/or a different application to be notified. In some examples, the one or more operations can be performed without (1) needing to communicate with an application (e.g., the application that provided the one or more operations and/or another application identified in the one or more operations) and/or (2) the application executing before, during, and/or after performing the one or more operations. In some examples, one or more operations defined by a first application can be used by a second application different from the first application. For example, a first application can define an operation to turn on a light associated with the first application, the operation callable and/or usable by a second application. In some examples, the intent provided by an application can be defined semantically such that UI view manager 340 and/or intent manager 350 interprets the intent and identifies one or more operations to be performed on device 300 to satisfy the intent. In such examples, the intent is defined in a syntax that UI view manager 340 and/or intent manager 350 is able to interpret. In some examples, an intent as described above works in configurations where display of a UI view is separated from processing of operations related to the UI view. For example, a first device can be provided an archive corresponding to a UI view (e.g., as described above) and, when interactions and/or events occur with respect to the UI view, the first device communicates with a second device that is managing the UI view to identify one or more operations to be performed. In such an example, notifications of inputs and/or events are communicated between the devices and other operations described herein occur as described herein except that results are transmitted from the second device to the first device. In some examples, when a second device is managing a UI view displayed on a first device, the first device can handle some interactions with the UI view without communicating with the second device. For example, some interactions can correspond to operations that the first device can resolve without needing to communicate with the second device (e.g., the first device and/or the second device can disable certain operations (e.g., outputting media on the first device) and/or enable certain operation (e.g., opening a webpage on a browser of the first device).

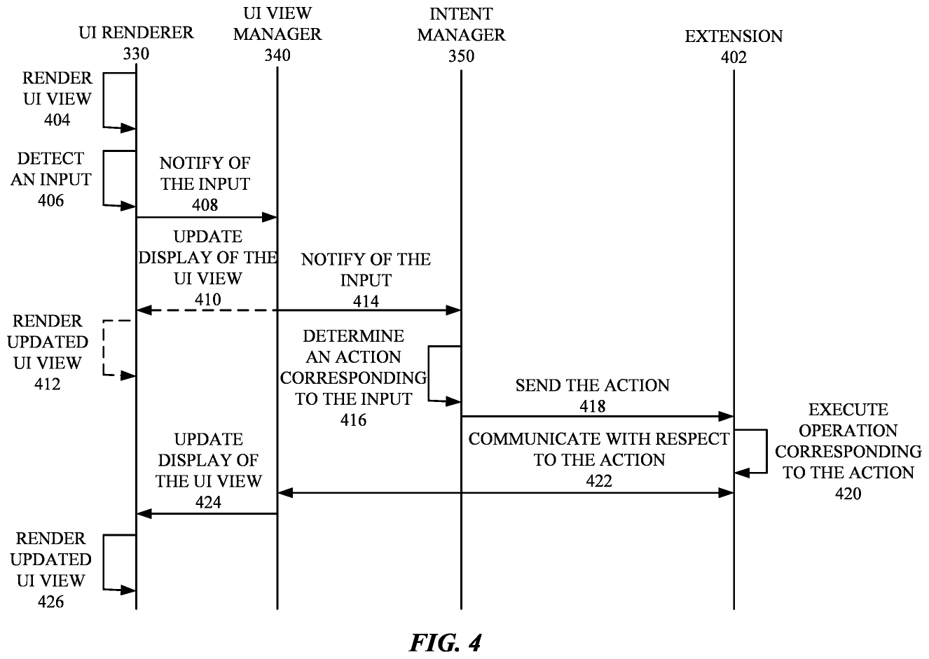

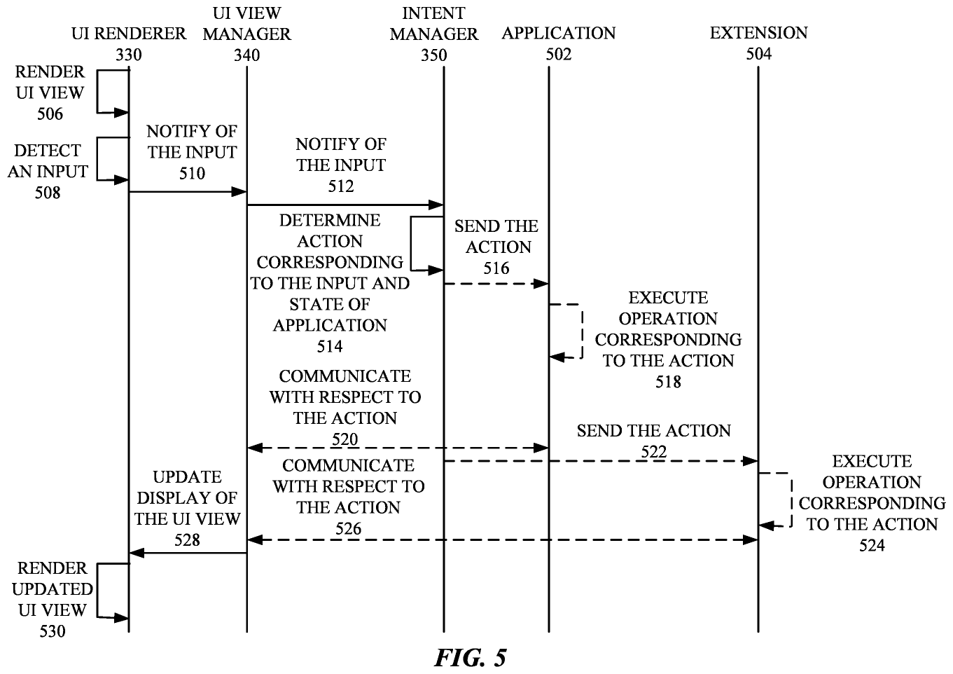

In some examples, intent manager 350 stores a mapping of UI elements, types of UI input (e.g., tap, select, swipe, tap-and-hold, rotate, double tap, and/or the like), and/or applications (e.g., first application 360, first extension 370, second application 380, and/or second extension 390) to identify (1) an operation defined by an application and/or (2) an application to communicate the occurrence of the detected input and/or the operation defined by the application. In some examples, UI view manager 340 sends a request for a result of the mapping to a detected input to receive the result. In other examples, UI view manager 340 sends a request for intent manager 350 to resolve the detected input without intent manager 350 needing to resolve the detected input via UI view manager 340. In some examples of the description above, a first virtual button can be mapped to a first operation of first extension 370, such that when an input is detected with respect to the first virtual button that the first operation provided by first extension 370 is performed and/or first extension 370 is notified. In some examples of the description above, a second virtual button can be mapped to a second operation of first extension 370 when a detected input is of a first type (e.g., a tap input rather than a non-tap input), such that when an input of the first type is detected with respect to the second virtual button that the second operation provided by first extension 370 is performed and/or first extension 370 is notified. Such results of interactions will be described further below with respect to FIGS. 4 and 5.

FIG. 4 is a block diagram illustrating different operations that occur with respect to different processes (e.g., one or more processes described above with respect to FIG. 3) of a device (e.g., compute system 100, device 200, and/or device 300) to handle an interaction with a UI view in accordance with some examples. In the block diagrams of FIGS. 4-5, the vertical lines for the different processes represent operations that are performed with respect to respective processes. For example, 404 is performed by UI renderer 330, 408 is sent by UI renderer 330 and received by UI view manager 340, and 422 includes one or more communications between extension 402 and UI view manager 340.

As illustrated, the processes of the device in FIG. 4 include UI renderer 330, UI view manager 340, intent manager 350, and extension 402 (e.g., first application 360, first extension 370, second application 380, and/or second extension 390). As mentioned above, it should be recognized that one or more processes can be combined and/or split into multiple processes and/or one or more processes can be executing on a different device from the device.

In some examples, operations illustrated in FIG. 4 occur after extension 402 has defined one or more operations to be performed by UI view manager 340 and/or intent manager 350 in response to detecting particular types of input. Such definitions can be (1) provided to UI view manager 340 and/or intent manager 350 and (2) used to determine how to respond to input.

At 404, UI renderer 330 (and/or UI host 320, as described above) renders (e.g., generates and/or displays) a UI view. In some examples, the UI view includes a portion (e.g., one or more UI elements) corresponding to extension 402 (e.g., sometimes referred to as a UI view and/or a UI element corresponding to extension 402). In some examples, the UI view is managed by a system process (e.g., UI host 320 and/or UI view manager 340, as described above) of the device including UI renderer 330. For example, the UI view can be a lockscreen, a homescreen, a notification center, and/or a portion thereof for the device, with UI elements corresponding to one or more different applications and/or an operating system (e.g., operating system 310).

At 406, UI renderer 330 (and/or UI host 320, as described above) detects an input (e.g., a user input, such as a tap or non-tap input) with respect to the UI view. At 408, in some examples, in response to detecting the input, UI renderer 330 (and/or UI host 320, as described above) notifies UI view manager 340 of the input. In other examples, UI renderer 330 (and/or UI host 320, as described above) notifies UI view manager 340 of the input in response to determining that the input is a valid input with respect to (e.g., intentional, directed to, and/or above a threshold (e.g., time, length, and/or distance)) the UI view. While FIG. 4 illustrates UI renderer 330 notifying UI view manager 340, it should be recognized that, in some examples, UI view manager 340 is not notified by UI renderer 330 and instead intent manager 350 is notified by UI renderer 330.

In some examples, at 410, UI view manager 340 responds to the notification in 408. In such examples, the response can include a request to update display of the UI view based on the input. In some examples, the response is sent without needing to (1) notify intent manager 350 and/or (2) communicate with extension 402. In such examples, the response is handled by UI view manager 340 using one or more operations defined by extension 402 and provided to UI view manager 340 as described above. In examples that the response is handled by UI view manager 340, 414-426 do not occur. In other examples, the response is sent by UI view manager 340 before, during (e.g., at least partially in parallel), and/or after notifying intent manager 350 and/or communicating with extension 402 with respect to the input. In some examples, at 412, in response to receiving the request to update display of the UI view, UI renderer (and/or UI host 320, as described above) renders (e.g., generates and/or displays) an updated UI view. In examples where intent manager 350 and/or extension 402 are communicated with by UI view manager 340, the updated UI view can be updated again depending on a result of an operation performed by intent manager 350 and/or extension 402 (e.g., as shown at 426). In such examples, the updated UI view is performed optimistically assuming that the one or more operations corresponding to the input would resolve successfully (e.g., before the one or more operations are performed).

At 414, in response to receiving the notification in 408 (e.g., and/or identifying an application corresponding to a UI element for which the input is directed), UI view manager 340 notifies intent manager 350 of the input. In some examples, the notification to intent manager 350 includes an identification of an application (e.g., extension 402) corresponding to the input, an identification of a UI element corresponding to the input, and/or an identification of a type of input of the input.

At 416, in response to being notified of the input, intent manager 350 determines an action (e.g., corresponding to, including, and/or representing one or more operations defined by extension 402) corresponding to the input. In some examples, the action is determined using a mapping as described above.

At 418, in response to determining the action (e.g., and in response to the action requiring a communication with extension 402), intent manager 350 sends an identification of the action to extension 402. In some examples, the identification includes information in the notification provided to intent manager 350 (e.g., as described above) and/or information defined in the action. In some examples, the identification of the action is performed based on how intent manager 350 communicates with extension 402 (e.g., different methods are used for different actions and/or different endpoints are used for different actions such that a communication does not need to include an identification of the action).

At 420, in response to receiving the identification of the action, extension 402 executes one or more operations corresponding to the action. In some examples, to execute the one or more operations, extension 402 initiates execution and/or transitions into an active state (e.g., as a background process and, in some examples, not a foreground process) (e.g., extension 402 was not executing before receiving the identification of the action, while the UI view was rendered, and/or while the input was detected). In some examples, such operations require extension 402 to communicate with other extensions and/or other applications, on the device including extension 402 and/or on a different device.

At 422, in response to executing at least one operation of the one or more operations (and, in some examples, all operations of the one or more operations), extension 402 communicates with respect to the action. In some examples, such communications include extension 402 indicating a result of at least one operation of the one or more operations (e.g., that the operation was successful or not). In some examples, such communications include a request to update an archive and/or UI view stored by UI view manager 340. In such examples, the request to update the archive can be a first communication to UI view manager 340 in response to executing at least one operation of the one or more operations. In other examples, the request to update the archive is a response to a request from UI view manager 340 for an update to the archive. For example, extension 402 can send a communication to UI view manager 340 indicating that extension 402 needs to update the archive, and, in response to receiving the communication, UI view manager 340 can send the request the update to the archive to extension 402. In some examples, an update to the archive and/or a UI view can be a first communication to UI view manager 340 in response to executing at least one operation of the one or more operations. In some examples, the update includes an update to the appearance of a UI element (e.g., a change in a set of instructions and/or an updated rendering of the UI element) and/or a UI view, an additional UI element and/or a UI view not provided before, a removal of a UI element and/or UI view provided before, and/or an update to a timeline corresponding to the archive to identify when and/or what should be displayed.

At 424, UI view manager sends UI renderer 330 (and/or UI host 320) a request to render a new and/or different UI view. The new and/or different UI view can be based on the update received at 422 and/or an event occurring with respect to a currently displayed UI view that is not based on the update received at 422. In some examples, the new and/or different UI view is rendered in response to receiving the update at 422. In other examples, the new and/or different UI is rendered after receiving the update at 422 and in response to UI view manager 340 determining that an event occurred to change the UI view. At 426, UI renderer 330 renders (e.g., generates and/or displays) an updated UI view according to the request at 424.

FIG. 5 is a block diagram illustrating different operations that occur with respect to different processes (e.g., one or more processes described above with respect to FIG. 3) of a device (e.g., compute system 100, device 200, and/or device 300) to contextually handle an interaction with a UI view in accordance with some examples.

As illustrated, the processes of the device in FIG. 5 include UI renderer 330, UI view manager 340, intent manager 350, application 502 (e.g., first application 360 and/or second application 380), and extension 504 (e.g., first extension 370 and/or second extension 390). In some examples, extension 504 corresponds to application 502 such that extension 504 is an extension of application 502. As mentioned above, it should be recognized that one or more processes can be combined and/or split into multiple processes and/or one or more processes can be executing on a different device from the device.

Similar to FIG. 4, in some examples, operations illustrated in FIG. 5 occur after extension 402 has defined one or more operations to be performed by UI view manager 340 and/or intent manager 350 in response to detecting particular types of input. Also similar to FIG. 4, 506 (corresponding to 404), 508 (corresponding to 406), 510 (corresponding to 408), and 512 (corresponding to 414) of FIG. 5 can occur in the same or similar manner to as described above with respect to FIG. 4. In addition, while FIG. 5 does not include operations corresponding to 410 and 412, such operations can occur in the same or similar manner in FIG. 5 as described above with respect to FIG. 4.

At 514, intent manager 350 (or, some examples, UI view manager 340) determines an action corresponding to the input (e.g., in the same or similar manner to as described above with respect to 416 in FIG. 4) and also determines a state of application 502 and/or the device including application 502. In some examples, the state of application 502 and/or the device including application 502 affects, controls, and/or is used to determine whether an indication of the action is sent to application 502 (e.g., as indicated by 516, and can be performed in the same or similar manner as described above with respect to 418) or extension 504 (e.g., as indicated by 522, and can be performed in the same or similar manner as described above with respect to 418). In such examples, the indication of the action is not sent to the other component (e.g., the indication of the action is not sent to extension 504 when sent to application 502 and the indication of the action is not sent to application 502 when sent to extension 504).

In some examples, determining the state includes determining whether application 502 is currently a foreground, background, suspended, hibernated, or closed process. In such examples, depending on a configuration of intent manager 350 (e.g., with respect to application 502, such as intent manager 350 is configured to communicate with application 502 when application 502 is a foreground or background process but not a suspended, hibernated, or closed process), intent manager 502 sends the identification of the action to either application 502 or extension 504. In some examples, determining the state includes determining whether application 502 and/or extension 504 is specifically configured to handle the action. In such examples, depending on a configuration of intent manager 350 (e.g., with respect to application 502 and/or extension 504, such as intent manager 350 is configured to communicate with application 502 when performing the action), intent manager 502 sends the identification of the action to either application 502 or extension 504.

In some examples, determining the state includes determining an amount of unused compute resources of the device including application 502. In such examples, depending on a configuration of intent manager 350 (e.g., with respect to application 502, such as that intent manager 350 is configured to communicate with application 502 when the device is idle and/or includes at least a predefined amount of unused compute resources), intent manager 502 sends the identification of the action to either application 502 or extension 504. In some examples, determining the state includes determining an amount of battery of the device including application 502 and/or whether the device is currently charging. In such examples, depending on a configuration of intent manager 350 (e.g., with respect to application 502, such as that intent manager 350 is configured to communicate with application 502 when the device has at least a predefined amount of battery remaining and/or is currently charging), intent manager 502 sends the identification of the action to either application 502 or extension 504. It should be recognized that other types of state can be used to determine whether to send the indication of the action to application 502 or extension 504. In some examples, the indication of the action can be sent to both application 502 and extension 504 depending on a configuration of intent manager 350 (e.g., with respect to application 502 and/or extension 504).

In some examples, the configuration of intent manager 350 (as described above with respect to whether to send to application 502 and/or extension 504) is included in information provided by extension 504 and/or application 502 when establishing a mapping of an input or a type of input to an action.

After sending the indication of the action, 518 (corresponding to 420), 524 (corresponding to 420), 520 (corresponding to 422), 526 (corresponding to 422), 528 (corresponding to 424 and based on communication received by UI view manager 340 (e.g., at 526 or 520 or most recently if sent by both application 502 and extension 504)), and 530 (corresponding to 426) of FIG. 5 can occur in the same or similar manner to as described above with respect to FIG. 4.

FIG. 6 is a flow diagram illustrating a method (e.g., method 600) for a system process to handle user input corresponding to user-interface elements in accordance with some examples. Some operations in method 600 are, optionally, combined, the orders of some operations are, optionally, changed, and some operations are, optionally, omitted.

In some examples, method 600 is performed at a system process (e.g., an operating system process such as a daemon that manages interactions between a renderer of the computer system and one or more applications) (e.g., UI view manager 340 and/or intent manager 350) of a computer system (e.g., compute system 100, device 200, and/or device 300). In some examples, the computer system is a phone, a tablet, a laptop, a desktop computer, and/or a wearable device.

At 602, while the computer system is displaying a user-interface view (e.g., a widget and/or one or more graphical user-interface elements) managed by (e.g., directed by, associated with, and/or corresponding to) the system process, the system process receives (e.g., while the computer system is displaying a user-interface view) a first input (e.g., a tap input or a non-tap input, such as a swipe input, a gaze input, a mouse click, an air gesture, and/or a hold and press input) (e.g., at 406 or at 508) corresponding to (e.g., directed to, at a location of, and/or with respect to) a user-interface element (e.g., an icon, a virtual button, a virtual slider, and/or a toggle) (e.g., managed by the system process, as described above) of the user-interface view. In some examples, the first input is received from a renderer (e.g., UI renderer 330) of the computer system. In some examples, the first input is received from a host (e.g., UI host 320) configured to control what is displayed in a user interface managed by an operating system (e.g., operating system 310) of the computer system. In some examples, the user-interface view is displayed by a renderer (e.g., UI renderer 330) of the computer system, with the system process instructing the renderer what to display. In some examples, the system process causes the user-interface view to be displayed. In some examples, before the computer system displays the user-interface view, the user-interface view is stored by the system process to be displayed in accordance with a determination that display criteria are met. In some examples, a process different from the system process (e.g., a different system process and/or a process that is not a system process and instead a user process (e.g., application process)) causes the user-interface view to be displayed. In some examples, the user-interface view is displayed (1) on a lockscreen of the computer system (e.g., while the computer system is in a locked state, with a reduced number of accessible features than when in an unlocked state), (2) on a homescreen of the computer system (e.g., while the computer system is displaying one or more user-interface elements that, when selected, cause a user interface of a corresponding application to be displayed), (3) in a respective user interface of a respective application executing on the computer system, the respective application different from an application corresponding to the user-interface view, and/or (4) in a notification user interface of the computer system (e.g., while the computer system is displaying one or more notifications received by the computer system from one or more processes (e.g., a process executing on the computer system and/or a process executing on a computer system different from the computer system)).

At 604, while the computer system is displaying the user-interface view managed by the system process and in response to receiving the first input, the system process causes execution of an operation (e.g., an action and/or a set of instructions corresponding to an action) (e.g., at 420, at 518, or at 524) corresponding to the user-interface element, wherein execution of the operation is performed by an application (e.g., in the foreground while concurrently displaying the user-interface view or in the background) (e.g., a respective application with one or more graphical user interface elements displayable by the computer system (e.g., installed via an application stored of the computer system) or an extension of the respective application (e.g., a part of the respective application that is configured to execute separate from the respective application but, in some examples, that is installed with the respective application (e.g., via a single install request))) (e.g., first application 360, first extension 370, second application 380, second extension 390, extension 402, application 502, or extension 504) corresponding to the user-interface element. In some examples, causing execution of the operation includes identifying the application and sending, to a second system process (e.g., UI view manager 340 and/or intent manager 350) different from the system process, an instruction to identify a respective operation corresponding to the user-interface element (and, in some examples, corresponding to a type of input of the first input). In some examples, causing execution of the operation includes identifying the application and, in response to identifying the operation, identifying the operation by looking up operations corresponding to the user-interface element (and, in some examples, corresponding to a type of input of the first input). In some examples, the operation is provided by the application. In some examples, an identification of the operation with an identification of the user-interface element is provided to the system process by the application before the computer system displays the user-interface view.

At 606, while the computer system is displaying the user-interface view managed by the system process and after causing execution of the operation, the system process receives (e.g., while the computer system is displaying a user-interface view), from the application, a communication (e.g., a message, a request, and/or an instruction) corresponding to a change (e.g., a visual change and/or a change to an appearance of the user-interface view) (e.g., at 422, at 520, or at 526) to the user-interface view. In some examples, the communication includes an update to the user-interface view. In some examples, the communication includes a new user-interface view to replace the user-interface view. In some examples, after sending the communication, the application stops executing.

At 608, while the computer system is displaying the user-interface view managed by the system process and in response to receiving the communication, the system process updates, based on the communication, display of the user-interface view (e.g., at 424 or at 528). In some examples, updating the user-interface view includes a request to display an updated user-interface view to the renderer and/or the host described above.

In some examples, the operation includes modifying a state of a second computer system (e.g., an accessory, an output device, a display generation component, and/or a vehicle) different from the computer system or modifying a local variable of the application. In some examples, the second computer system has a corresponding application that enables the state of the second computer system to be modified by the computer system. In some examples, the computer system is in communication (e.g., via a wired and/or wireless connection) with the second computer system. In some examples, the second computer system is remote and/or separate from the computer system.

In some examples, the user-interface element includes a toggle (e.g., a control graphically representing (1) different possible states (e.g., two or more) of the toggle and (2) a current state of the toggle, where the control, in response to the computer system detecting input, visually changes to graphically represent a new state for the current state of the toggle). In some examples, the toggle is a binary control configured to be used to change between two different states.

In some examples, while the computer system is displaying the user-interface view managed by the system process, the system process receives a second input corresponding to a second user-interface element of the user-interface view. In some examples, the second user-interface element is different from the user-interface element. In some examples, while the computer system is displaying the user-interface view managed by the system process and in response to receiving the second input, the system process causes execution of a second operation corresponding to the second user-interface element. In some examples, execution of the second operation is performed by the application. In some examples, the second operation is different from the operation. In some examples, while the computer system is displaying the user-interface view managed by the system process and in response to receiving the second input, the system process updates (e.g., at the system process) (e.g., based on receiving the second input) (e.g., in accordance with an anticipated result of execution of the second operation) display of the user-interface view (e.g., of the second user-interface element and/or the user-interface view) (e.g., at least partially in parallel with causing execution of the second operation) (e.g., at 410 and 412). In some examples, the second user-interface element is updated before the second operation has finished, before a communication is received from the application based on the second input, and/or before a state indicated by the updated display of the user-interface view is established. In some examples, the user-interface view is updated before executing the second operation. In some examples, an instruction to update the user-interface view is sent before sending an instruction to execute the second operation. In some examples, after updating display of the user-interface view, the computer system updates (e.g., at the system process) display of the user-interface view back to a state before (e.g., directly and/or immediately before) updating display of the user-interface view in accordance with a determination that execution of the second operation failed.

In some examples, the application is in an inactive state (e.g., not running in the background and/or the foreground, not executing, and/or suspended) before (e.g., immediately before and/or within a particular amount of time before (e.g., 10 seconds to 10 minutes)) causing execution of the operation. In some examples, causing execution of the operation includes causing the application to transition into an active state (e.g., initiate execution, begin running in the background and/or the foreground, and/or transition into an unsuspended state).

In some examples, causing execution of the operation includes causing the application to initiate (e.g., execute and/or run) (e.g., change from an inactive state to an active state) in the background of the computer system. In some examples, initiating in the background does not include displaying a user interface of the application.

In some examples, the change to the user-interface view includes a change to a timeline of how to update display of the user-interface view in response to one or more events occurring.

In some examples, the change to the user-interface view includes a rendered portion of the user-interface view. In some examples, the rendered portion is used to update display of the user-interface view. In some examples, updating display of the user-interface view includes displaying the rendered portion.

In some examples, while the computer system is displaying a second user-interface view concurrently with the user-interface view, the system process receives a third input corresponding to the second user-interface view. In some examples, the second user-interface view is managed by the system process. In some examples, the second user-interface view is different from the user-interface view. In some examples, while the computer system is displaying the second user-interface view concurrently with the user-interface view and in response to receiving the third input, the system process causes execution of a third operation corresponding to the second user-interface view. In some examples, execution of the third operation is performed by a second application (e.g., first application 360, first extension 370, second application 380, second extension 390, extension 402, application 502, or extension 504) different from the application. In some examples, the second application corresponds to the second user-interface view. In some examples, while the computer system is displaying the second user-interface view concurrently with the user-interface view and after causing execution of the third operation, the system process receives, from the second application, a second communication corresponding to a change to the second user-interface view. In some examples, while the computer system is displaying the second user-interface view concurrently with the user-interface view and in response to receiving the second communication, the system process updates, based on the second communication, display of the second user-interface view.

In some examples, while the computer system is displaying the user-interface view managed by the system process, the system process receives a fourth input corresponding to a third user-interface element of the user-interface view. In some examples, the third user-interface element is different from the user-interface element. In some examples, while the computer system is displaying the user-interface view managed by the system process and in response to receiving the fourth input, the system process causes execution of a fourth operation corresponding to the third user-interface element. In some examples, execution of the fourth operation is performed by the application. In some examples, while the computer system is displaying the user-interface view managed by the system process and after causing execution of the fourth operation, the system process receives, from the application, a third communication corresponding to a second change to the user-interface view. In some examples, the second change to the user-interface view is different from the change to the user-interface view. In some examples, while the computer system is displaying the user-interface view managed by the system process and in response to receiving the third communication, the system process updates, based on the third communication, display of the user-interface view. In some examples, updating, based on the third communication, display of the user-interface view includes updating the third user-interface element.

Note that details of the processes described above with respect to method 600 (e.g., FIG. 6) are also applicable in an analogous manner to other methods described herein. For example, method 700 optionally includes one or more of the characteristics of the various methods described above with reference to method 600. For example, the system process of method 600 can be the system process of method 700. For brevity, these details are not repeated below.

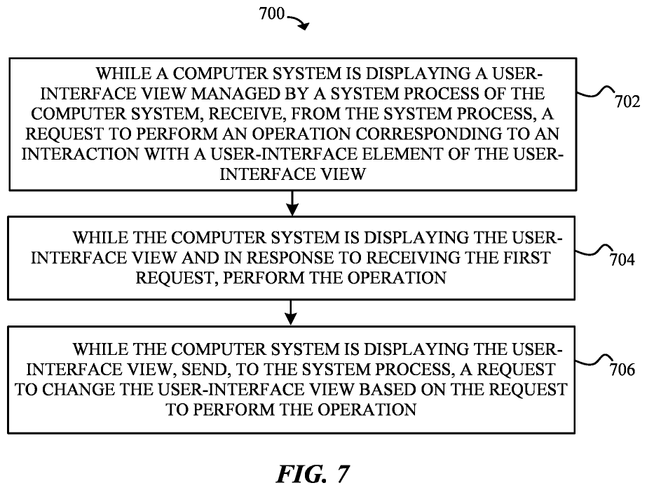

FIG. 7 is a flow diagram illustrating a method (e.g., method 700) for an application to handle user input corresponding to user-interface elements in accordance with some examples. Some operations in method 700 are, optionally, combined, the orders of some operations are, optionally, changed, and some operations are, optionally, omitted.

In some examples, method 700 is performed at an application (e.g., a respective application with one or more graphical user interface elements displayable by a computer system (e.g., installed via an application stored of the computer system) or an extension of the respective application (e.g., a part of the respective application that is configured to execute separate from the respective application but, in some examples, that is installed with the respective application (e.g., via a single install request))) (e.g., first application 360, first extension 370, second application 380, second extension 390, extension 402, application 502, or extension 504) of a computer system (e.g., compute system 100, device 200, and/or device 300). In some examples, the computer system is a phone, a tablet, a laptop, a desktop computer, or a wearable device.

At 702, while the computer system is displaying a user-interface view (e.g., a widget and/or one or more graphical user-interface elements) managed by a system process (e.g., an operating system process such as a daemon that manages interactions between a renderer of the computer system and one or more applications) (e.g., UI view manager 340 and/or intent manager 350) of the computer system, the application receives, from the system process, a request to perform an operation (e.g., an action and/or a set of instructions corresponding to an action) (e.g., at 418, at 516, or at 522) corresponding to an interaction (e.g., a tap input or a non-tap input, such as a swipe input, a gaze input, a mouse click, an air gesture, and/or a hold and press input) with a user-interface element (e.g., a displayed element and/or a region of the user-interface view) (e.g., managed by the system process, as described above) of the user-interface view, wherein the user-interface element corresponds to (e.g., is of, relates to, is part of, and/or is configured by) the application. In some examples, an identification of the user-interface element and/or a rendered version of the user-interface element is sent from the application to the system process before the user-interface view is displayed. In some examples, interactions with the user-interface element are managed by the application. In some examples, the user-interface view is displayed by a renderer (e.g., UI renderer 330) of the computer system, with the system process instructing the renderer what to display. In some examples, the system process causes the user-interface view to be displayed. In some examples, before the computer system displays the user-interface view, the user-interface view is stored by the system process to be displayed in accordance with a determination that display criteria are met. In some examples, a process different from the system process (e.g., a different system process and/or a process that is not a system process and instead a user process (e.g., the application)) causes the user-interface view to be displayed. In some examples, the user-interface view is displayed (1) on a lockscreen of the computer system (e.g., while the computer system is in a locked state, with a reduced number of accessible features than when in an unlocked state), (2) on a homescreen of the computer system (e.g., while the computer system is displaying one or more user-interface elements that, when selected, cause a user interface of a corresponding application to be displayed), (3) in a respective user interface of a respective application executing on the computer system, the respective application different from the application, and/or (4) in a notification user interface of the computer system (e.g., while the computer system is displaying one or more notifications received by the computer system from one or more processes (e.g., a process executing on the computer system and/or a process executing on a computer system different from the computer system)).

At 704, while the computer system is displaying the user-interface view managed by the system process of the computer system and in response to receiving the request to perform the operation, the application performs the operation (e.g., at 420 or at 518).

At 706, while the computer system is displaying the user-interface view managed by the system process of the computer system, the application sends (e.g., in response to receiving the request (e.g., before performing the operation) and or in response to performing the operation), to the system process, a request (e.g., at 422, at 520, or at 526) to change (e.g., a visual change and/or a change to an appearance of the user-interface view) the user-interface view based on the request to perform the operation (e.g., receiving the request to perform the operation and/or performing the operation results in the change to the user-interface view). In some examples, the request to change includes an update to the user-interface view. In some examples, the request to change the user-interface view includes a new user-interface view to replace the user-interface view. In some examples, after sending the request to change the user-interface view, the application ceases executing (e.g., in the background).

In some examples, the operation includes modifying a state of a second computer system (e.g., an accessory, an output device, a display generation component, and/or a vehicle) different from the computer system or modifying a local variable of the application. In some examples, the second computer system has a corresponding application that enables the state of the second computer system to be modified by the computer system. In some examples, the computer system is in communication (e.g., via a wired and/or wireless connection) with the second computer system. In some examples, the second computer system is remote and/or separate from the computer system.

In some examples, in response to receiving the request to perform the operation and before performing the operation, the application transitions (e.g., at the application) from an inactive state (as described above with respect to method 600) to an active state (as described above with respect to method 600).

In some examples, transitioning from the inactive state to the active state includes initiating the application in the background of the computer system. In some examples, initiating the application in the background does not include displaying a user interface of the application. In some examples, the application performs the operation in the background of the computer system and/or transitions back to an inactive state without initiating in the foreground of the computer system.

In some examples, the request to change the user-interface view includes a request to change to a timeline of how to update display of the user-interface view in response to one or more events occurring.

In some examples, the request to change the user-interface view includes a rendered portion of the user-interface view. In some examples, the rendered portion is used to update display of the user-interface view. In some examples, updating display of the user-interface view includes displaying the rendered portion.

In some examples, display of the user-interface element changes based on the interaction with the user-interface element while and separate from performing the operation. In some examples, the user-interface element is updated before the operation has finished, before sending the request to change the user-interface view based on the request to perform the operation, and/or before a state indicated by the changes is established by the application. In some examples, the user-interface element is changed before executing the operation. In some examples, an instruction to change display of the user-interface element is sent before sending the request to perform the operation. In some examples, after changing display of the user-interface element, the computer system updates (e.g., at the system process) display of the user-interface view back to a state before (e.g., directly and/or immediately before) updating display of the user-interface view in accordance with a determination that execution of the operation failed.

Note that details of the processes described above with respect to method 700 (e.g., FIG. 7) are also applicable in an analogous manner to other methods described herein. For example, method 600 optionally includes one or more of the characteristics of the various methods described above with reference to method 700. For example, the application of method 700 can be the application of method 700. For brevity, these details are not repeated below.

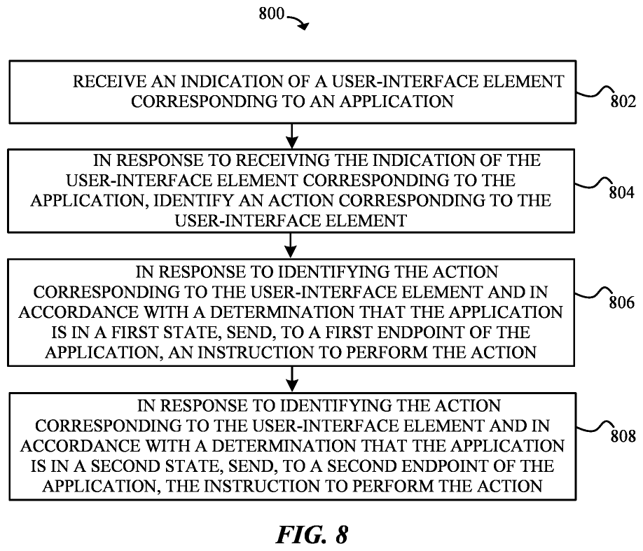

FIG. 8 is a flow diagram illustrating a method (e.g., method 800) for sending an instruction to different endpoints of an application in accordance with some examples. Some operations in method 800 are, optionally, combined, the orders of some operations are, optionally, changed, and some operations are, optionally, omitted.

In some examples, method 800 is performed at a system process (e.g., an operating system process such as a process that maintains a list of user-interface elements (e.g., corresponding to different applications) and their corresponding actions that result from input corresponding to respective user-interface elements) (e.g., UI view manager 340 and/or intent manager 350) of a computer system (e.g., compute system 100, device 200, and/or device 300). In some examples, the computer system is a phone, a tablet, a laptop, a desktop computer, or a wearable device.

At 802, the system process receives an indication of (e.g., data indicating and/or an input directed to) a user-interface element (e.g., as described above with respect to 600) (e.g., at 408, at 414, at 510, or at 512) corresponding to an application (e.g., as described above with respect to 600) (e.g., first application 360, first extension 370, second application 380, second extension 390, extension 402, application 502, or extension 504). In some examples, the indication is received by the system process while a user-interface view corresponding to the computer system is displayed (e.g., as described above with respect to 600). In some examples, the indication is received while the application is not executing. In some examples, the indication is received while the application is executing in the background (and, in some examples, not displaying a user interface of the application). In some examples, the indication corresponds to input (e.g., a tap input or a non-tap input, such as a swipe input, a gaze input, a mouse click, an air gesture, and/or a hold and press input) received that corresponds to the user-interface element. In some examples, the indication of the user-interface element includes an indication of the application. In some examples, the indication of the user-interface element includes an indication of a type of input received with respect to the user-interface element. In some examples, the indication is received by a second system process (e.g., UI view manager 340 and/or intent manager 350) different from the system process such as a daemon that manages interactions between a renderer of the computer system and one or more applications. In some examples, the indication is not received from a renderer (e.g., UI renderer 330) and/or a host (e.g., configured to control what is displayed in a user interface managed by an operating system of the computer system) (e.g., UI host 320) of the computer system.

At 804, in response to receiving the indication of the user-interface element corresponding to the application, the system process identifies an action (e.g., an operation, a method, a function, and/or a set of one or more instructions) (e.g., at 416 or at 514) corresponding to the user-interface element. In some examples, a mapping of the user-interface element and the action is received from the application before receiving the indication of the user-interface element corresponding to the application.

At 806, in response to identifying the action corresponding to the user-interface element and in accordance with a determination that the application is in a first state (e.g., the application is currently executing in the background and/or the application is currently executing and/or not executing a particular operation), the system process sends (e.g., directly and/or indirectly via an intermediary computer system, device and/or system, such as a server and/or a set of one or computer systems), to a first endpoint of the application (e.g., an endpoint corresponding to a feature of the application that requires the application to execute), an instruction (e.g., a request) (e.g., at 516) to perform the action.

At 808, in response to identifying the action corresponding to the user-interface element and in accordance with a determination that the application is in a second state (e.g., the application is not currently executing in the background and/or the application is currently executing and/or not executing a particular operation) different from the first state, the system process sends, to a second endpoint (e.g., an extension) of the application different from the first endpoint of the application, the instruction (e.g., at 522) to perform the action. In some examples, the determination that the application is in the first state or the second state is performed without communicating with the application. In some examples, in accordance with a determination that the application is in the second state, the computer system forgoes sending (e.g., directly and/or indirectly), to the second endpoint, the instruction to perform the action. In some examples, in accordance with a determination that the application is in the first state, the computer system forgoes sending (e.g., directly and/or indirectly), to the first endpoint, the instruction to perform the action. In some examples, the first endpoint is an extension of the application while the second endpoint is not an extension of the application or vice-versa. In some examples, the first endpoint is a full version of the application while the second endpoint is not the full version of the application or vice-versa. In some examples, the first endpoint is a first version of the application while the second endpoint is a second version of the application different from the first version. In some examples, the first endpoint is a more reduced version of the application than a version of the application corresponding to the second endpoint.

In some examples, the user-interface element is included in a user-interface view (e.g., a widget) of the application. In some examples, the user-interface view includes a plurality of user-interface elements. In some examples, one or more user-interface elements of the plurality of user-interface elements cause different actions to be performed with the same or different types of inputs as the user-interface element.

In some examples, the first endpoint corresponds to the application (e.g., the first endpoint corresponds a first process of the application that initiates execution of the application (e.g., the application begins executing in a background of the computer system) in response to receiving a communication via the first endpoint) (e.g., first application 360, second application 380, or application 502). In some examples, the second endpoint corresponds to an extension (e.g., first extension 370, second extension 390, extension 402, or extension 504) of the application (e.g., the second endpoint corresponds a first process of the extension that initiates execution of the extension (e.g., the extension begins executing in a background of the computer system) in response to receiving a communication via the second endpoint). In some examples, the extension executes (e.g., is configured to execute) separately from the application (e.g., the extension executes in a foreground and/or background of the computer system without the application executing in a foreground and/or background of the computer system).

In some examples, the first state corresponds to an active state (e.g., that the application is currently executing (e.g., when sending the operation to perform the operation) in a background and/or foreground of the computer system).

In some examples, the second state corresponds to an inactive state (e.g., that the application is not currently executing (e.g., when sending the operation to perform the operation) in a background and/or foreground of the computer system).

In some examples, the system process receives a second indication of a second user-interface element corresponding to the application. In some examples, the second indication is different from the indication. In some examples, the second user-interface element is different from the user-interface element. In some examples, in response to receiving the second indication of the second user-interface element corresponding to the application, the system process identifies a second action corresponding to the second user-interface element. In some examples, the second action is different from the action. In some examples, in response to identifying the second action corresponding to the second user-interface element, the system process sends, to the first endpoint of the application, an instruction to perform the second action. In some examples, the instruction to perform the second action is sent to the first endpoint in accordance with a determination that the second action and/or the second user-interface element is a first type. In some examples, the instruction to perform the action is selectively sent to the first endpoint or the second endpoint in accordance with a determination that the action and/or the user-interface element is a second type different from the first type. In some examples, the second action is specific to the first endpoint and not the second endpoint. In some examples, the second action is specific to the application and not the extension. In some examples, the second type is always sent to the first endpoint and never to the second endpoint.

In some examples, the system process receives a third indication of a third user-interface element corresponding to the application. In some examples, the third indication is different from the indication. In some examples, the third user-interface element is different from the user-interface element. In some examples, in response to receiving the third indication of the third user-interface element corresponding to the application, the system process identifies a third action corresponding to the third user-interface element. In some examples, the third action is different from the action. In some examples, in response to identifying the third action corresponding to the third user-interface element, the system process sends, to the second endpoint of the application, an instruction to perform the third action. In some examples, the instruction to perform the third action is sent to the second endpoint in accordance with a determination that the third action and/or the third user-interface element is a third type different from the first and second type. In some examples, the third action is specific to the second endpoint and not the first endpoint. In some examples, the third action is specific to the extension and not the application. In some examples, the third type is always sent to the second endpoint and never to the first endpoint.

In some examples, the system process receives a fourth indication of a fourth user-interface element corresponding to a second application different from the application. In some examples, the fourth indication is different from the indication. In some examples, the fourth user-interface element is different from the user-interface element. In some examples, in response to receiving the fourth indication of the fourth user-interface element corresponding to the second application, the system process identifies a fourth action corresponding to the fourth user-interface element. In some examples, the fourth action is different from the action. In some examples, in response to identifying the fourth action corresponding to the fourth user-interface element, the system process sends, to a second computer system different from the computer system, an instruction to perform the fourth action. In some examples, the instruction to perform the fourth action is sent to the second computer system in accordance with a determination that the fourth action and/or the fourth user-interface element is a fourth type different from the first type. In some examples, the fourth action is specific to the second computer system. In some examples, the fourth type is always sent to the second computer system and not to a respective endpoint of the computer system. In some examples, the system process receives a fifth indication of a fifth user-interface element corresponding to a third application different from the application. In some examples, the fifth indication is different from the indication and the fourth indication. In some examples, the fifth user-interface element is different from the user-interface element and the fourth user-interface element. In some examples, in response to receiving the fifth indication of the fifth user-interface element corresponding to the third application, the system process identifies a fifth action corresponding to the fifth user-interface element. In some examples, the fifth action is different from the action and the fourth action. In some examples, in response to identifying the fifth action corresponding to the fifth user-interface element, the system process sends, to a respective endpoint of the computer system, an instruction to perform the fifth action. In some examples, the instruction to perform the fifth action is sent to the respective endpoint in accordance with a determination that the fifth action and/or the fifth user-interface element is a fifth type different from the first and fourth type. In some examples, the fifth action is specific to the respective endpoint and not the second computer system. In some examples, the fourth type is always sent to the respective endpoint and never to the second computer system.

Note that details of the processes described above with respect to method 800 (e.g., FIG. 8) are also applicable in an analogous manner to other methods described herein. For example, method 900 optionally includes one or more of the characteristics of the various methods described above with reference to method 800. For example, the system process of method 800 can be the system process of method 900. For brevity, these details are not repeated below.

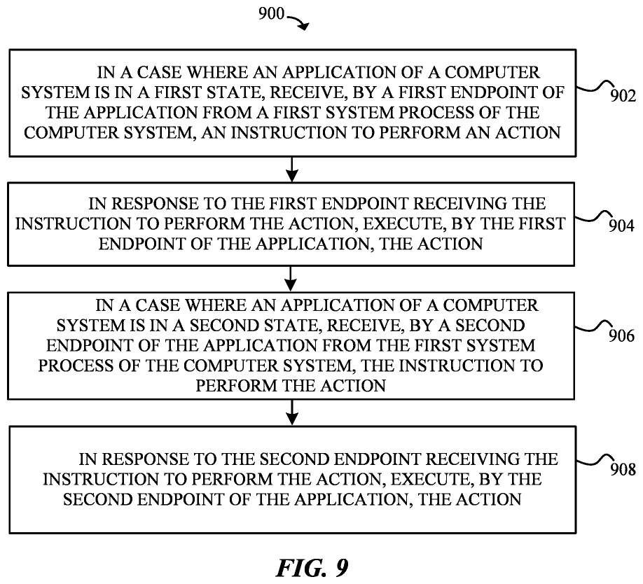

FIG. 9 is a flow diagram illustrating a method (e.g., method 900) for handling instructions to perform operations in accordance with some examples. Some operations in method 900 are, optionally, combined, the orders of some operations are, optionally, changed, and some operations are, optionally, omitted.

In some examples, method 900 is performed at a computer system (e.g., compute system 100, device 200, and/or device 300). In some examples, the computer system is a phone, a tablet, a laptop, a desktop computer, or a wearable device.

At 902, in a case where an application (e.g., as described above with respect to method 600) (e.g., first application 360, first extension 370, second application 380, or second extension 390, extension 402, application 502, or extension 504) of the computer system (e.g., as described above with respect to method 600) is in a first state (e.g., as described above with respect to method 600), the computer system receives, by a first endpoint of the application from a first system process (e.g., as described above with respect to method 600) of the computer system, an instruction (e.g., at 418 or at 516) to perform an action (e.g., as described above with respect to method 800), wherein the action corresponds to a user-interface element of a user-interface view (e.g., as described above with respect to method 600) managed by a second system process (e.g., the first system process and/or a different system process than the first system process) of the computer system. In some examples, the user-interface element corresponds to the application.

At 904, in response to the first endpoint receiving the instruction to perform the action, the computer system executes, by the first endpoint of the application, the action (e.g., as described above with respect to method 800) (e.g., at 518).

At 906, in a case where the application is in a second state (e.g., as described above with respect to method 800) different from the first state, the computer system receives, by a second endpoint of the application from the first system process, the instruction (e.g., at 522) to perform the action, wherein the second endpoint is different from the first endpoint.

At 908, in response to the second endpoint receiving the instruction to perform the action, the computer system executes, by the second endpoint of the application, the action (e.g., at 524). In some examples, the first endpoint does not execute the action when the second endpoint executes the action (e.g., the second endpoint executes the action without the first endpoint executing the action). In some examples, the second endpoint does not execute the action when the first endpoint executes the action (e.g., the first endpoint executes the action without the second endpoint executing the action).

In some examples, the user-interface element is included in a user-interface view (e.g., a widget) of the application. In some examples, the user-interface view includes a plurality of user-interface elements. In some examples, one or more user-interface elements of the plurality of user-interface elements cause different actions to be performed with the same or different types of inputs as the user-interface element.

In some examples, the first endpoint corresponds to the application (e.g., the first endpoint corresponds a first process of the application that initiates execution of the application (e.g., the application begins executing in a background of the computer system) in response to receiving a communication via the first endpoint) (e.g., first application 360 or second application 380). In some examples, the second endpoint corresponds to an extension (e.g., first extension 370, second extension 390, extension 402, or extension 504) of the application (e.g., the second endpoint corresponds a first process of the extension that initiates execution of the extension (e.g., the extension begins executing in a background of the computer system) in response to receiving a communication via the second endpoint). In some examples, the extension executes (e.g., is configured to execute) separately from the application (e.g., the extension executes in a foreground and/or background of the computer system without the application executing in a foreground and/or background of the computer system).

In some examples, the first state corresponds to an active state (e.g., that the application is currently executing (e.g., when sending the operation to perform the operation) in a background and/or foreground of the computer system).

In some examples, the second state corresponds to an inactive state (e.g., that the application is not currently executing (e.g., when sending the operation to perform the operation) in a background and/or foreground of the computer system).

In some examples, in a case where a second action is a second type of action different from a respective type of action of the action, the computer system receives, by the first endpoint of the application from the first system process of the computer system, an instruction to perform the second action, wherein the second action corresponds to a second user-interface element of a second user-interface view managed by the second system process of the computer system. In some examples, in response to the first endpoint receiving the instruction to perform the second action, the computer system executes, by the first endpoint of the application, the second action. In some examples, the instruction to perform the action is selectively sent to the first endpoint or the second endpoint in accordance with a determination that the action and/or the user-interface element is the respective type. In some examples, the second action is specific to the first endpoint and not the second endpoint. In some examples, the second action is specific to the application and not the extension. In some examples, the second type is always sent to the first endpoint and never to the second endpoint.

In some examples, in a case where a third action is a third type of action different from a type of action of the action, the computer system receives, by the second endpoint of the application from the first system process of the computer system, an instruction to perform the third action, wherein the third action corresponds to a third user-interface element of a third user-interface view managed by the second system process of the computer system. In some examples, in response to the second endpoint receiving the instruction to perform the third action, the computer system executes, by the second endpoint of the application, the third action. In some examples, the third action is specific to the second endpoint and not the first endpoint. In some examples, the third action is specific to the extension and not the application. In some examples, the third type is always sent to the second endpoint and never to the first endpoint.

Note that details of the processes described above with respect to method 900 (e.g., FIG. 9) are also applicable in an analogous manner to the methods described herein. For example, method 800 optionally includes one or more of the characteristics of the various methods described above with reference to method 900. For example, the second system process of method 900 can be the system process of method 800. For brevity, these details are not repeated below.

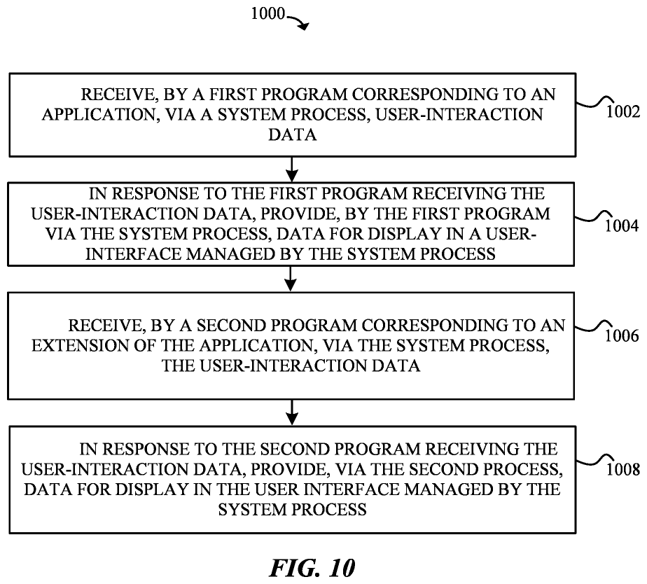

FIG. 10 is a flow diagram illustrating a method (e.g., method 1000) for handling user-interaction data from the perspective of multiple programs in accordance with some examples. Some operations in method 1000 are, optionally, combined, the orders of some operations are, optionally, changed, and some operations are, optionally, omitted.

In some examples, method 1000 is performed at a computer system (e.g., compute system 100, device 200, and/or device 300) storing and/or executing a plurality of programs (e.g., first application 360, first extension 370, second application 380, second extension 390, or extension 504). In some examples, the computer system is a phone, a tablet, a laptop, a desktop computer, or a wearable device.

At 1002, a first program (e.g., as described above with respect to method 900) (e.g., first application 360 or second application 380) corresponding to an application (e.g., as described above with respect to method 900) of the computer system receives, via a system process (e.g., as described above with respect to method 900) (e.g., UI view manager 340 and/or intent manager 350) different from the first program (e.g., and the second program described below), user-interaction data (e.g., as described above with respect to the instruction to perform the action of method 900) (e.g., at 516). In some examples, the plurality of programs includes the first program but does not include the system process. In some examples, the user-interaction data corresponds to an interaction with a user-interface element of a user-interface view managed by the system process (e.g., as described above with respect to method 900).

At 1004, in response to receiving the user-interaction data, the first program provides, via (e.g., to) the system process, data (e.g., as described above with respect to the request to change the user-interface of method 700) for display in a user interface (e.g., as described above with respect to method 700) managed by the system process (e.g., as described above with respect to method 900) (e.g., at 520).

At 1006, a second program (e.g., first extension 370, second extension 390, extension 402, or extension 504) corresponding to an extension (e.g., as described above with respect to method 600) of the application receives, via the system process, the user-interaction data. In some examples, the second program is (1) generated by (e.g., is a portion of, downloaded with, included in, and/or caused to be executed by) the first program and (2) configured to execute separate from the first program. In some examples, either the first program or the second program (e.g., not both) receive the user-interaction data. In such examples, the determination for which program receives the user-interaction data is as described above.

At 1008, in response to receiving the user-interaction data, the second program provides, via the system process, data (e.g., the same data or different data than what is provided by the first program in response to receiving the user-interaction data) for display in the user interface managed by the system process (e.g., at 526).

Note that details of the processes described above with respect to method 1000 (e.g., FIG. 10) are also applicable in an analogous manner to the methods described herein. For example, method 1000 optionally includes one or more of the characteristics of the various methods described above with reference to method 600. For example, the system process of method 900 can be the system process of method 600. For brevity, these details are not repeated below.

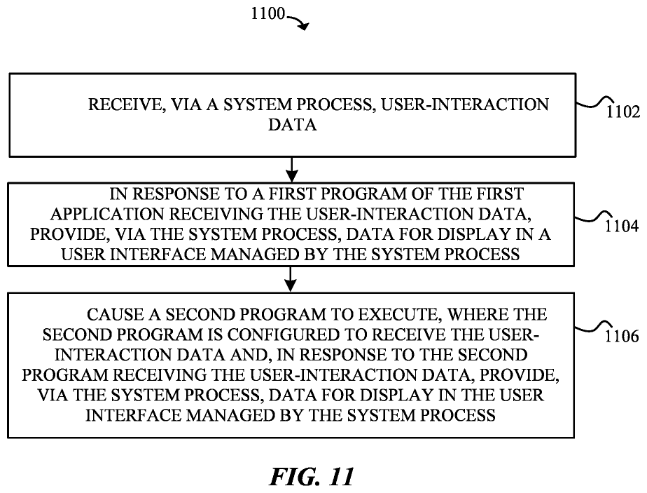

FIG. 11 is a flow diagram illustrating a method (e.g., method 1100) for handling instructions to perform operations in accordance with some examples. Some operations in method 1100 are, optionally, combined, the orders of some operations are, optionally, changed, and some operations are, optionally, omitted.

In some examples, method 1100 is performed at a computer system (e.g., compute system 100, device 200, and/or device 300). In some examples, the computer system is a phone, a tablet, a laptop, a desktop computer, or a wearable device.

At 1102, an application (e.g., first application 360, first extension 370, second application 380, second extension 390, application 502, extension 402, or extension 504) of the computer system receives, via a system process (e.g., as described above with respect to method 900) (e.g., UI view manager 340 and/or intent manager 350) different from the application, user-interaction data (e.g., as described above with respect to the instruction to perform the action of method 900) (e.g., at 516). In some examples, the user-interaction data corresponds to an interaction with a user-interface element of a user-interface view managed by the system process (e.g., as described above with respect to method 900).

At 1104, in response to a first program (e.g., application 502) of the application receiving the user-interaction data, the application provides, via the system process, data (e.g., as described above with respect to the request to change the user-interface of method 700) for display in a user interface (e.g., as described above with respect to method 700) managed by the system process (e.g., as described above with respect to method 700) (e.g., at 520).

At 1106, the application causes a second program (e.g., an extension of the application) (as described above) (e.g., extension 402 or extension 504) to execute. In some examples, the second program is configured to execute separate from the first program. In some examples, the second program is configured to receive, via the system process, the user-interaction data (e.g., at 522). In some examples, the second program is configured to, in response to the second program receiving the user-interaction data, provide, via the system process, data (e.g., the same data or different data than what is provided by the first program in response to receiving the user-interaction data) for display in the user interface managed by the system process (e.g., at 526).

Note that details of the processes described above with respect to method 1100 (e.g., FIG. 11) are also applicable in an analogous manner to the methods described herein. For example, method 700 optionally includes one or more of the characteristics of the various methods described above with reference to method 1100. For example, the system process of method 1100 can be the system process of method 700. For brevity, these details are not repeated below.

In some examples of the methods described above, the following examples apply. In some examples, the user-interface view corresponds to a widget (e.g., the user-interface view is of a widget). In some examples, the widget and/or the user-interface view is not live (e.g., the user-interface view is not continuously updated but rather is updated in response to events occurring and/or a particular amount of time passing, the particular amount of time exceeding the amount of time that a user would interpret as continuous. In some examples, the user-interface view updates according to a timeline that is updated through an operation between (1) a system process and (2) an application and/or a program/process of an application. In some examples, different user-interface views are (1) rendered and/or generated ahead of when the user-interface views are displayed and (2) are provided to a system process managing the different user-interface views for display according to the timeline. In some examples, a system process manages updating user-interface views and/or corresponding data as described above with respect to FIGS. 3-5. In some examples, an extension (e.g., the second endpoint of method 800 or 900 or the second program of FIG. 10 or 11) of an application is defined in the same programming language as the application and/or shares at least a portion of the same resources (e.g., data in memory and/or processors) as the application (e.g., the first endpoint of method 800 or 900 or the first program of FIG. 10 or 11). In some examples, an application executes the same operations when receiving a particular instruction from a system process regardless of the type of device and/or channel used to communicate with the application (e.g., operations are encapsulated). In some examples, an operation performed by a system process is any arbitrary amount of code provided by an application. In some examples, an operation performed by the system process is defined semantically such that the system process interprets the operation on different types of computer systems differently (e.g., and, in some examples, the same). In some examples, an operation is identified and/or determined by a third system process (e.g., the second system process described above or a different system process). In such examples, the third system process can analyze code of the application and/or operations provided to the third system process to identify the operation for encapsulation by the third system process for a system process (e.g., the first system process and/or the second system process). In some examples, an operation to update a user-interface view requires multiple communications between a system process and an application (e.g., communications including a request to change the user-interface view to the system process, a request for missing content to the application, and a response with the missing content to the system process). In some examples, an application is downloaded from an application store (e.g., an online store including multiple applications from different developers and/or entities). In such examples, the application can include an extension (e.g., the second endpoint of method 800 or 900 or the second program of FIG. 10 or 11). In some examples, a user-interface view is displayed in a lockscreen and/or homescreen of a computer system.

The foregoing description, for purpose of explanation, has been described with reference to specific examples. However, the illustrative discussions above are not intended to be exhaustive or to limit the disclosure to the precise forms disclosed. Many modifications and variations are possible in view of the above teachings. The examples were chosen and described in order to best explain the principles of the techniques and their practical applications. Others skilled in the art are thereby enabled to best utilize the techniques and various examples with various modifications as are suited to the particular use contemplated.

Although the disclosure and examples have been fully described with reference to the accompanying drawings, it is to be noted that various changes and modifications will become apparent to those skilled in the art. Such changes and modifications are to be understood as being included within the scope of the disclosure and examples as defined by the claims.

As described above, one aspect of the present technology is the gathering and use of data available from various sources to improve how a device interacts with a user. The present disclosure contemplates that in some instances, this gathered data can include personal information data that uniquely identifies or can be used to contact or locate a specific person. Such personal information data can include demographic data, location-based data, telephone numbers, email addresses, home addresses, or any other identifying information.

The present disclosure recognizes that the use of such personal information data, in the present technology, can be used to the benefit of users. For example, the personal information data can be used to change how a device interacts with a user. Accordingly, use of such personal information data enables better user interactions. Further, other uses for personal information data that benefit the user are also contemplated by the present disclosure.

The present disclosure further contemplates that the entities responsible for the collection, analysis, disclosure, transfer, storage, or other use of such personal information data will comply with well-established privacy policies and/or privacy practices. In particular, such entities should implement and consistently use privacy policies and practices that are generally recognized as meeting or exceeding industry or governmental requirements for maintaining personal information data private and secure. For example, personal information from users should be collected for legitimate and reasonable uses of the entity and not shared or sold outside of those legitimate uses. Further, such collection should occur only after receiving the informed consent of the users. Additionally, such entities would take any needed steps for safeguarding and securing access to such personal information data and ensuring that others with access to the personal information data adhere to their privacy policies and procedures. Further, such entities can subject themselves to evaluation by third parties to certify their adherence to widely accepted privacy policies and practices.

Despite the foregoing, the present disclosure also contemplates embodiments in which users selectively block the use of, or access to, personal information data. That is, the present disclosure contemplates that hardware and/or software elements can be provided to prevent or block access to such personal information data. For example, in the case of image capture, the present technology can be configured to allow users to select to “opt in” or “opt out” of participation in the collection of personal information data during registration for services.

Therefore, although the present disclosure broadly covers use of personal information data to implement one or more various disclosed embodiments, the present disclosure also contemplates that the various embodiments can also be implemented without the need for accessing such personal information data. That is, the various embodiments of the present technology are not rendered inoperable due to the lack of all or a portion of such personal information data. For example, content can be displayed to users by inferring location based on non-personal information data or a bare minimum amount of personal information, such as the content being requested by the device associated with a user or other non-personal information.

What is claimed is:

1. A method, comprising:
at a system process of a computer system:
receiving an indication of a user-interface element corresponding to an application;
in response to receiving the indication of the user-interface element corresponding to the application, identifying an action corresponding to the user-interface element; and
in response to identifying the action corresponding to the user-interface element:
in accordance with a determination that the application is in a first state, sending, to a first endpoint of the application, an instruction to perform the action; and
in accordance with a determination that the application is in a second state different from the first state, sending, to a second endpoint of the application different from the first endpoint of the application, the instruction to perform the action.

2. The method of claim 1, wherein the user-interface element is included in a user-interface view of the application.

3. The method of claim 1, wherein the first endpoint corresponds to the application, wherein the second endpoint corresponds to an extension of the application, and wherein the extension executes separately from the application.

4. The method of claim 1, wherein the first state corresponds to an active state.

5. The method of claim 1, wherein the second state corresponds to an inactive state.

6. The method of claim 1, further comprising:
receiving a second indication of a second user-interface element corresponding to the application;
in response to receiving the second indication of the second user-interface element corresponding to the application, identifying a second action corresponding to the second user-interface element; and
in response to identifying the second action corresponding to the second user-interface element, sending, to the first endpoint of the application, an instruction to perform the second action.

7. The method of claim 1, further comprising:
receiving a third indication of a third user-interface element corresponding to the application;
in response to receiving the third indication of the third user-interface element corresponding to the application, identifying a third action corresponding to the third user-interface element; and
in response to identifying the third action corresponding to the third user-interface element, sending, to the second endpoint of the application, an instruction to perform the third action.

8. The method of claim 1, further comprising:
receiving a fourth indication of a fourth user-interface element corresponding to a second application different from the application;
in response to receiving the fourth indication of the fourth user-interface element corresponding to the second application, identifying a fourth action corresponding to the fourth user-interface element;
in response to identifying the fourth action corresponding to the fourth user-interface element, sending, to a second computer system different from the computer system, an instruction to perform the fourth action;
receiving a fifth indication of a fifth user-interface element corresponding to a third application different from the application;
in response to receiving the fifth indication of the fifth user-interface element corresponding to the third application, identifying a fifth action corresponding to the fifth user-interface element; and
in response to identifying the fifth action corresponding to the fifth user-interface element, sending, to a respective endpoint of the computer system, an instruction to perform the fifth action.

9. A non-transitory computer-readable storage medium storing one or more programs configured to be executed by one or more processors of a computer system executing a system process, the one or more programs including instructions for:
receiving an indication of a user-interface element corresponding to an application;
in response to receiving the indication of the user-interface element corresponding to the application, identifying an action corresponding to the user-interface element; and
in response to identifying the action corresponding to the user-interface element:
in accordance with a determination that the application is in a first state, sending, to a first endpoint of the application, an instruction to perform the action; and
in accordance with a determination that the application is in a second state different from the first state, sending, to a second endpoint of the application different from the first endpoint of the application, the instruction to perform the action.

10. A computer system executing a system process, comprising:
one or more processors; and
memory storing one or more programs configured to be executed by the one or more processors, the one or more programs including instructions for:
receiving an indication of a user-interface element corresponding to an application;
in response to receiving the indication of the user-interface element corresponding to the application, identifying an action corresponding to the user-interface element; and
in response to identifying the action corresponding to the user-interface element:
in accordance with a determination that the application is in a first state, sending, to a first endpoint of the application, an instruction to perform the action; and
in accordance with a determination that the application is in a second state different from the first state, sending, to a second endpoint of the application different from the first endpoint of the application, the instruction to perform the action.
